(19) United States
(12) Patent Application Publication
(10) Pub. No.: US 2026/0151744 A1
(43) Pub. Date: Jun. 4, 2026

(54) NANOFILTRATION MEMBRANE FOR MICROPOLLUTANT REMOVAL

(71) Applicant: King Fahd University of Petroleum and Minerals, Dhahran (SA)

(72) Inventors: Nadeem BAIG, Dhahran (SA); Asif MATIN, Dhahran (SA)

(73) Assignee: King Fahd University of Petroleum and Minerals, Dhahran (SA)

(21) Appl. No.: 18/963,858

(22) Filed: Nov. 29, 2024

(51) Int. Cl. B01D 69/14; B01D 69/10; B01D 71/02; B01D 71/56; B01D 71/68; C02F 1/00; C02F 101/30

(52) U.S. Cl. CPC B01D 69/14111; B01D 69/10; B01D 69/148; B01D 71/0211; B01D 71/56; B01D 71/68; C02F 1/001; B01D 2323/21819; B01D 2323/30; C02F 2101/30

(57) ABSTRACT

A filtration membrane includes a polysulfone (PFS) membrane support, and a crosslinked polyamide layer disposed on the PFS membrane support. The crosslinked polyamide layer includes a network formed by polycondensation between diethylenetriamine and trimesoyl chloride, and graphene oxide (GO) nanosheets covalently bonded to the network via a linking spacer. The linking spacer includes a backbone chain having at least 8 backbone atoms. The backbone chain has a plurality of amine groups including —NH— and —NH₂, and the linking spacer is bonded to the graphene oxide nanosheets via a —Si—O— bond and bonded to the network via reactions between trimesoyl chloride and the plurality of amine groups. A filtration method includes filtering a mixture including water and an organic molecule through the filtration membrane to generate a water permeate.

### STATEMENT REGARDING PRIOR DISCLOSURE BY THE INVENTORS

Aspects of the present disclosure are described in Applicant's publication “Incorporating functionalized graphene oxide into diethylene triamine-based nanofiltration membranes can improve the removal of emerging organic micropollutants” Journal of Colloid and Interface Science, Volume 676, (2024), pp. 657-669, which is incorporated herein by reference in its entirety.

### BACKGROUND

### Technical Field

The present disclosure is directed generally to filtration membranes and more specifically to filtration membranes based on crosslinked polyamide and functionalized graphene oxide.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The number of water-stressed regions is increasing amidst the global water crisis. The provision of clean and potable water in a sustainable manner is identified as the challenge of this century. Over-utilization and pollution of groundwater and freshwater sources have made it essential to explore alternative sources of fresh water. The primary alternative water sources that can be considered to obtain water for use or reuse include sea water and wastewater from domestic, industrial, and municipal sources. In particular, wastewater reclamation is an attractive and viable option due to the much lower salt concentration, which makes lower-pressure operation possible.

Generally, any type of wastewater, whether domestic or industrial, can be a feed of high complexity with a mixture of organic, inorganic, microbial, and/or colloidal compounds. Currently, a combination of diverse techniques is used to treat and purify wastewater. However, more recently, organic compounds of small molecular sizes originating from pharmaceuticals, personal care products, pesticides, etc. have been detected in trace levels (ng-μg/L) in wastewater effluents. Moreover, some have also been detected in drinking water and natural waters, e.g., rivers and lakes. These compounds are known to harm human health, such as carcinogens, endocrine disruptors, and mutagens. The current combination of techniques used to treat industrial and domestic wastewater cannot wholly eliminate and/or remove many of these compounds.

Researchers have investigated a wide variety of techniques for the effective removal of different organic micropollutants (OMPs). These include adsorption, biodegradation, coagulation-flocculation, membrane filtration, oxidation, ozonation, photolysis and membrane bioreactors, sedimentation, chlorination, sand filtration, activated sludge advanced oxidation processes (AOPs), etc. Among these, using membranes for this application has proven to be a promising technology because of their high removal efficiency and marginal solute deterioration. Based on the average pore size, membranes can be classified as microfiltration, ultrafiltration, nanofiltration (NF), and reverse osmosis (RO). Due to their high rejection capabilities, the latter two are increasingly used to remove emerging organic micropollutants (OMPs).

Conventionally, commercial NR and RO membranes are thin-film composite (TFC) membranes with a thin selective layer of polyamide at the top. Although quite dense and possessing a small average pore size (in the sub-nanometer range), these membranes suffer from poor rejection of organic compounds due to one or more of the following reasons: (1) electrically neutral, (2) low-molecular-weight, and (3) highly hydrophilic. Due to lower steric hindrance and reduced electrostatic and hydrophobic interactions (H-bonding, Π-Π bonding), a good proportion of these molecules can diffuse through the membrane layers and into the permeate.

A viable alternative is the fabrication of thin-film nanocomposite (TFN) membranes with nanofillers such as nanoparticles or nanosheets embedded in the polyamide active layer. The nanofillers have the ability to enhance the rejection of OMPs by altering interactions between the organic molecules and functional groups in the membrane. The nanochannels created in the polyamide active layer facilitate the easy passage of water molecules and simultaneously provide steric hindrance to the larger-sized organic molecules. Also, the hydrophilic nanofillers, e.g., metal oxides, silica, and graphene oxide, interact strongly with the hydrophilic groups of the organic compounds, resulting in enhanced retention of the latter.

Two-dimensional materials are receiving significant attention in the design of advanced membranes. However promising, the widespread implementation of these TFN membranes is limited due to some obstacles. One of the most significant challenges in nanocomposite membranes is the binding and compatibility of the nanoparticles with the polymer matrix. Therefore, proper selection of nanomaterials and prevention strategies should be adopted to avoid leaching nanoparticles from the TFN membranes. However, as observed by several researchers, the increase in concentration of nanoparticles is limited due to the agglomeration and interference in interfacial polymerization reaction at higher concentrations. Appropriate functionalization of the nanomaterials can help to develop more stable TFN membranes. Therefore, surface functionalization of the nanoparticles is widely adopted to obtain TFN membranes with high binding affinity, increased loading capacity, and improved separation performance.

Several researchers have explored the potential and feasibility of using functionalized nanofillers in TFN membranes. For instance, Rajaeian and co-workers employed TiO₂ nanoparticles modified with amino groups of a silane coupling agent to fabricate TFN membranes for better filtration properties. They observed a 2-fold increase in water flux while maintaining a salt rejection of about 50%. Similarly, Zhang and colleagues (Zhang, H., et al., 2017. Carboxyl-functionalized graphene oxide polyamide nanofiltration membrane for desalination of dye solutions containing monovalent salt. J Memb Sci 539, 128-137, incorporated herein by reference in its entirety) synthesized TFN membranes with graphene oxide functionalized with carboxyl groups to desalinate dye solutions containing monovalent salt. They observed a permeate flux>100 LMH and a rejection of around 98% for the cocaine dye for the improved GO loading. Likewise, there are many studies on functionalized TFN membranes for desalination salt removal. [Subrahmanya, T. M., 2023. Effect of functionalized nanodiamonds and surfactants mediation on the nanofiltration performance of polyamide thin-film nanocomposite membranes. Desalination 555, 116540; Shen, H., Wang, S., Li, Y., Gu, K., Zhou, Y., Gao, C., 2019. MeSiCl₃ functionalized polyamide thin film nanocomposite for low pressure RO membrane desalination. Desalination 463, 13-22; and Zarrabi, H., Yekavalangi, M. E., Vatanpour, V., Shockravi, A., Safarpour, M., 2016. Improvement in desalination performance of thin film nanocomposite nanofiltration membrane using amine-functionalized multiwalled carbon nanotube. Desalination 394, 83-90]. However, studies investigating the removal of OMPs from water using membranes with functionalized nanofillers are limited. Given the seriousness of water contamination by emerging micropollutants, there is a pressing need to investigate such TFN membranes for this application.

Accordingly, an object of the present disclosure is to provide a nanofiltration membrane for improving the removal of organic micropollutants. The nanofiltration membrane can be prepared by incorporating functionalized graphene oxide into a crosslinked polyamide network.

### SUMMARY

In an exemplary embodiment, a method for developing a nanofiltration membrane is described. The filtration membrane includes: a polysulfone (PFS) membrane support; and a crosslinked polyamide layer disposed on the PFS membrane support and including a network formed by polycondensation between diethylenetriamine and trimesoyl chloride, and graphene oxide (GO) nanosheets covalently bonded to the network via a linking spacer. The linking spacer includes a backbone chain having at least 8 backbone atoms. The backbone chain has a plurality of amine groups including —NH— and —NH₂, and the linking spacer is bonded to the graphene oxide nanosheets via a —Si—O— bond and bonded to the network via reactions between trimesoyl chloride and the plurality of amine groups.

In some embodiments, the linking spacer conforms to a formula of *—SiR¹R²—[R³—NL]ₓ-R⁴—NH—**, where: * represents one end of the linking spacer bonded to an oxygen atom of the GO nanosheets, ** represents another end of the linking spacer bonded to a carbonyl group of the network, R¹ and R² are each independently a hydroxyl group, a methyl group or an ethyl group, R³ is a hydrocarbon group having 1-12 carbon atoms, L is a hydrogen atom or a single bond connected to a carbonyl group of the network, x is an integer of 1 or more, where when x is an integer of 2 or more, each R³ is independently a hydrocarbon group having 1-12 carbon atoms, and each L is independently a hydrogen atom or a single bond connected to a carbonyl group of the network, and R⁴ is a hydrocarbon group having 1-12 carbon atoms.

In some embodiments, R¹ and R² are each independently a hydroxyl group or a methyl group, R³ is a hydrocarbon group having 1-4 carbon atoms, x is an integer of 1 to 6, where when x is an integer of 2 to 6, each R³ is independently a hydrocarbon group having 1-4 carbon atoms, and each L is independently a hydrogen atom or a single bond connected to a carbonyl group of the network, and R⁴ is a hydrocarbon group having 1-4 carbon atoms.

In some embodiments, the linking spacer conforms to a formula of *—Si(OH)₂—(CH₂)₃—N(L₁)-(CH₂)₂—N(L₂)-(CH₂)₂—NH—**, where: L₁ is a hydrogen atom or a single bond connected to a carbonyl group of the network, and L₂ is a hydrogen atom or a single bond connected to a carbonyl group of the network.

In some embodiments, at least one of L₁ or L₂ is a single bond connected to a carbonyl group of the network.

In some embodiments, the filtration membrane is formed by refluxing a mixture of GO, a silane agent and a solvent to obtain amine-functionalized GO nanosheets, the silane agent including the plurality of amine groups including —NH— and —NH₂. The method includes dipping the PFS membrane support in a first solution including the amine-functionalized GO nanosheets and diethylenetriamine. The method further includes removing the PFS membrane support from the first solution; The method further includes contacting the PFS membrane support with a second solution including trimesoyl chloride to form an initial film on the PFS membrane support. The method further includes crosslinking the initial film to obtain the filtration membrane.

In some embodiments, the silane agent conforms to a formula of Si(R⁵)_{y}(R⁶)_{z}—[R³—NL]ₓ-R⁴—NH₂, where: R⁵ each is independently a hydrolyzable group selected from the group consisting of a halogen atom and an alkoxyl group having 1-3 carbon atoms, R⁶ each is independently a methyl group and an ethyl group, y+z=3, where y is an integer of 1, 2 or 3, and z is an integer of 0, 1 or 2, R³ is a hydrocarbon group having 1-12 carbon atoms, L is a hydrogen atom or a single bond connected to a carbonyl group of the network, x is an integer of 1 or more, where when x is an integer of 2 or more, each R³ is independently a hydrocarbon group having 1-12 carbon atoms, and each L is independently a hydrogen atom or a single bond connected to a carbonyl group of the network, and R⁴ is a hydrocarbon group having 1-12 carbon atoms.

In some embodiments, the silane agent includes at least one selected from the group consisting of 2-[2-(3-trimethoxysilylpropylamino)ethylamino]ethylamine, N-(2-Aminoethyl)-11-aminoundecyltrimethoxysilane, N-(6-aminohexyl)aminomethyltriethoxy silane, N-2-(aminoethyl)-3-aminopropylmethyldimethoxysilane and N-2-(aminoethyl)-3-aminopropyltrimethoxysilane.

In some embodiments, the silane agent includes 2-[2-(3-trimethoxysilylpropylamino)ethylamino]ethylamine.

In some embodiments, the filtration membrane is further formed by preparing a dispersion of GO in ethanol by ultrasonication. The method includes adding the silane agent to the dispersion of GO to form the mixture. The refluxing is executed at a temperature of 80° C. for 12 hours to obtain the amine-functionalized GO nanosheets; the PFS membrane support was dipped in the first solution for about 5 minutes; and the crosslinking is executed at about 60° C. for about 10 minutes.

In some embodiments, the crosslinked polyamide layer is in the form of the GO nanosheets interspersed among particles.

In some embodiments, the particles have a lateral dimension of 50-300 nm, and the GO nanosheets have a lateral dimension of 100-900 nm.

In some embodiments, the GO nanosheets are not stacked or stacked by no more than 3 layers.

In some embodiments, the network is formed by polycondensation between diethylenetriamine, trimesoyl chloride, and diethylenetriamine-siloxy functionalized GO nanosheets, and the diethylenetriamine-siloxy functionalized GO nanosheets are reacted with the trimesoyl chloride and the diethylenetriamine.

In an exemplary embodiment, the filtration method, includes filtering a mixture including water and an organic molecule through the filtration membrane to generate a water permeate.

In some embodiments, the organic molecule includes at least one selected from the group consisting of acetaminophen, caffeine and bisphenol A.

In some embodiments, the organic molecule includes caffeine, a rejection efficiency of the filtration membrane is about 20% higher than a first comparative membrane that is the same as the filtration membrane but does not include the GO nanosheets and the linking spacer, and a rejection efficiency of a second comparative membrane is about 8% higher than the first comparative membrane, the second comparative membrane being the same as the filtration membrane but not including the GO nanosheets.

In some embodiments, the organic molecule includes bisphenol A, a rejection efficiency of the filtration membrane is about 30% higher than a comparative membrane that is the same as the filtration membrane but does not include the GO nanosheets and the linking spacer.

In some embodiments, a water flux rate of the filtration membrane is about 25% higher than a comparative membrane that is the same as the filtration membrane but does not include the GO nanosheets and the linking spacer.

In some embodiments, the filtration method further includes adjusting a flux rate and permeability of the filtration membrane by changing a length of the linking spacer.

The foregoing general description of the illustrative embodiments and the following detailed description thereof are merely exemplary aspects of the teachings of this disclosure and are not restrictive.

### BRIEF DESCRIPTION OF THE DRAWINGS

A more comprehensive appreciation of this disclosure and many of the attendant advantages thereof will be readily obtained as the same becomes better understood by reference to the following detailed description when considered in connection with the accompanying drawings.

FIG. 1A is a schematic diagram of a flow chart of a method of forming a filtration membrane, according to certain embodiments.

FIG. 1B is an illustration of the chemical structure of the polyamide active layer of the TFN membrane, according to certain embodiments.

FIG. 2A shows a transmission electron microscopy (TEM) image of graphene oxide (GO) at 200 nm scale bar, according to certain embodiments.

FIG. 2B shows a TEM image of graphene oxide at 100 nm scale bar, according to certain embodiments.

FIG. 2C shows a TEM image of graphene oxide at 50 nm scale bar, according to certain embodiments.

FIG. 2D shows a TEM image of amino-silane functionalized graphene oxide at 200 nm scale bar, according to certain embodiments.

FIG. 2E shows a TEM image of amino-silane functionalized graphene oxide at 100 nm scale bar, according to certain embodiments.

FIG. 2F shows a TEM image of amino-silane functionalized graphene oxide at 50 nm scale bar, according to certain embodiments.

FIG. 3A shows an X-ray photoelectron spectroscopy (XPS) spectrum of C1s of amino-silane functionalized graphene oxide, according to certain embodiments.

FIG. 3B shows an XPS spectrum of N1s of amino-silane functionalized graphene oxide, according to certain embodiments.

FIG. 3C shows an XPS spectrum of O1s of amino-silane functionalized graphene oxide, according to certain embodiments.

FIG. 3D shows an XPS spectrum of Si2p of amino-silane functionalized graphene oxide, according to certain embodiments.

FIG. 4 shows Fourier Transform Infrared (FTIR) spectra of membranes such as pristine, NFG, and FG, according to certain embodiments.

FIG. 5A shows an SEM image of membrane for a virgin polyamide at ×1,000 magnification, according to certain embodiments.

FIG. 5B shows an SEM image of membrane for the virgin polyamide at ×5,000 magnification, according to certain embodiments.

FIG. 5C shows an SEM image of membrane for the virgin polyamide at ×10,000 magnification, according to certain embodiments.

FIG. 5D shows an SEM image of membrane for GO-modified membranes at ×1,000 magnification, according to certain embodiments.

FIG. 5E shows an SEM image of membrane for GO-modified membranes at ×5,000 magnification, according to certain embodiments.

FIG. 5F shows an SEM image of membrane for GO-modified membranes at ×10,000 magnification, according to certain embodiments.

FIG. 6A shows an SEM image of the modified membrane with the sheet-like structure clearly visible at ×5,000 magnification, according to certain embodiments.

FIG. 6B shows an SEM image of the modified membrane with the sheet-like structure clearly visible at ×7,500 magnification, according to certain embodiments.

FIG. 6C shows an SEM image of the modified membrane with the sheet-like structure clearly visible at ×15,000 magnification, according to certain embodiments.

FIG. 7A shows a 3D atomic force microscopy (AFM) image of the pristine polyamide membrane, according to certain embodiments.

FIG. 7B shows a 3D AFM image of the NFG membrane, according to certain embodiments.

FIG. 7C shows a 3D AFM image of the FG membrane, according to certain embodiments.

FIG. 8 shows zeta potential values for membranes such as pristine, NFG, and FG at a neutral pH of ˜7, according to certain embodiments.

FIG. 9 shows average values of pure water flux for the membranes such as pristine, NFG, and FG at a pressure of 200 psi and a feed temperature of 24° C., according to certain embodiments.

FIG. 10A shows rejection and flux values for acetaminophen (ACT) organic micropollutants from synthetic feeds by membranes such as pristine, NFG, and FG at a pressure of ˜15 bars and a near-neutral pH, according to certain embodiments.

FIG. 10B shows rejection and flux values for caffeine (CFN) organic micropollutants from synthetic feeds by membranes such as pristine, NFG, and FG at a pressure of ˜15 bars and a near-neutral pH, according to certain embodiments.

FIG. 10C shows rejection and flux values for bisphenol A (BPA) organic micropollutants from synthetic feeds by membranes such as pristine, NFG, and FG at a pressure of ˜15 bars and a near-neutral pH, according to certain embodiments.

FIG. 10D shows rejection and flux values for amitriptyline HCL (ATT-HCL) organic micropollutants from synthetic feeds by membranes such as pristine, NFG, and FG at a pressure of ˜15 bars and a near-neutral pH, according to certain embodiments.

FIG. 11 shows enhancement in removal efficiencies after modification of a membrane with graphene oxide, according to certain embodiments.

FIG. 12A shows the variation of rejection with molecular radius critical OMP characteristics, according to certain embodiments.

FIG. 12B shows the variation of rejection with hydrophobicity critical OMP characteristics, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term ‘filtration membrane’ refers to a selectively permeable barrier designed to separate particles, solutes, and/or liquids based on size, charge, and/or chemical properties. Filtration membranes are used in various applications, including water purification, wastewater treatment, and gas separation. Filtration membranes can be constructed from a variety of materials, such as polymers, ceramics, and/or composite structures, and may feature different configurations, including microfiltration, ultrafiltration, nanofiltration, and/or reverse osmosis. The effectiveness of a filtration membrane is determined by its pore size, surface chemistry, and/or mechanical stability, which collectively influence its permeability, selectivity, and resistance to fouling. By allowing certain substances to pass while retaining others, filtration membranes play a crucial role in enhancing the quality of liquids or gases and are essential in numerous industrial and environmental processes.

As used herein, the term ‘linking spacer’ refers to a molecular component that functions as a connective bridge between various materials or functional groups within a composite structure, playing a role in enhancing the overall performance and stability of the material.

As used herein, the term ‘graphene oxide’ refers to a derivative of graphene that contains various oxygen-containing functional groups, such as hydroxyl, epoxy, and/or carboxyl groups. This modification enhances its hydrophilicity and reactivity compared to pristine graphene, making it suitable for a wide range of applications, including composite materials, energy storage, and environmental remediation. Graphene oxide typically exhibits a layered structure, which can be dispersed in aqueous solutions, allowing for easier processing and integration into different matrices. Its unique properties, including high surface area, mechanical strength, and electrical conductivity, combined with its functional groups, enable the design of advanced materials for applications such as filtration membranes, where it can improve mechanical stability and antifouling characteristics. Overall, graphene oxide serves as a versatile building block in nanotechnology and materials science, facilitating innovative approaches to various technological challenges.

As used herein, the term ‘silane agent’ refers to a compound that contains silicon and can react with other substances to form chemical bonds and/or itself to form siloxane bonds (Si—O—Si). These agents are typically used to modify surfaces, enhance adhesion, or create functional groups that improve compatibility with various materials. Silane agents can be categorized based on their reactivity, with some promoting crosslinking in polymers, while others may serve as coupling agents to bond organic materials to inorganic substrates. In the context of filtration membranes, silane agents are particularly valuable for enhancing the stability, hydrophobicity, and overall performance of the filtration membrane by facilitating stronger interactions between the filtration membrane components and the surrounding environment. Their ability to create robust networks contributes to the durability and efficacy of the filtration process, making them essential in advanced material design.

As used herein, the term ‘polymeric filtration support’ refers to a substrate made from one or more polymeric materials that serve as the foundational structure for filtration membranes. These supports are designed to provide mechanical strength, stability, and integrity to the filtration membrane, ensuring it can withstand operational stresses such as pressure and flow during filtration processes.

As used herein, the term ‘water flux’ refers to the rate at which water or an aqueous solution passes through a filtration membrane over a specific period, typically expressed in liters per square meter per hour (L/m²·h). It quantifies the efficiency of the filtration membrane in allowing water to permeate while retaining contaminants. Water flux is a parameter in evaluating membrane performance, as it reflects not only the filtration membrane's permeability but also its ability to operate effectively under varying pressures and conditions. A higher water flux indicates better flow rates and efficiency in filtration processes, making it an essential metric for assessing the viability of membranes in applications such as water treatment, wastewater management, and industrial separations.

Aspects of this disclosure are directed to a method to incorporate functionalized graphene oxide into diethylene triamine-based nanofiltration membranes that can improve the removal of emerging organic micropollutants. Functionalizing graphene oxide with amino silane enhances its cross-linking during the polyamide active layer formation via interfacial polymerization. The resulting TFN membranes exhibited increased hydrophilicity, leading to greater water permeability and additional permeation channels. This innovative approach significantly enhanced the filtration membrane's ability to reject a variety of common OMPs, leveraging size exclusion and improved functional interactions to ensure safer drinking water.

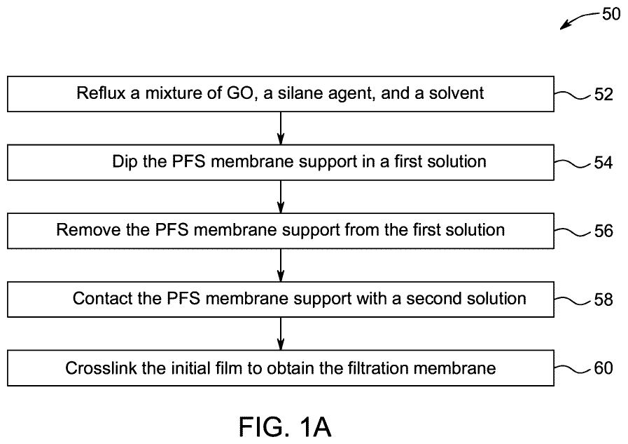

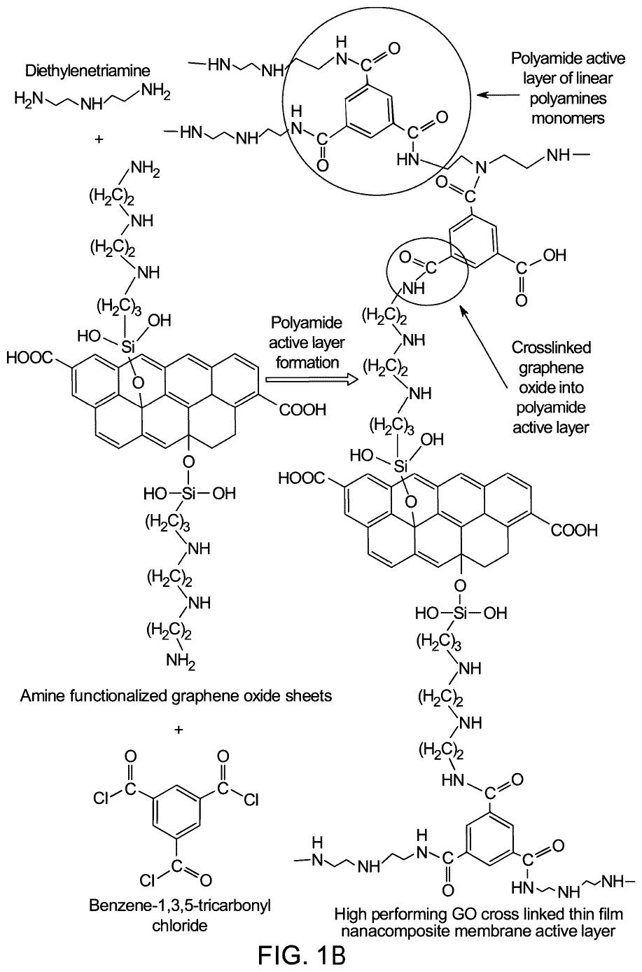

FIG. 1A illustrates a schematic flow chart of a method 50 of forming a filtration membrane. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes refluxing a mixture of graphene oxide (GO), a silane agent and a solvent to obtain amine-functionalized GO nanosheets. The silane agent includes a plurality of amine groups, including —NH— and —NH₂. Refluxing includes heating the mixture to about its boiling point and maintaining that temperature, allowing for continuous vaporization and condensation. In some embodiments, the temperature is set in a temperature of 50° C. to 120° C. e.g. at 50° C., 60° C., 70° C., 100° C., 120° C. or any values therebetween. In a preferred embodiment, the temperature is set at 80° C. This process facilitates enhanced interaction between the GO and the silane agent, promoting the chemical bonding of the silane agent, which contains amine groups (—NH— and —NH₂), onto the surface of the GO to obtain the amine-functionalized GO nanosheets. The presence of amine groups is pivotal as they significantly modify the surface chemistry of GO, enhancing its compatibility with various organic materials and improving its functional properties.

The solvent chosen plays a role in step 52 by dissolving the GO and the silane agent, ensuring uniform distribution and optimal reactivity during the reaction. As the mixture is refluxed, the silane agent undergoes hydrolysis, forming reactive silanol groups that can bond covalently to the hydroxyl groups on the surface of the GO. This reaction anchors the amine groups to the nanosheets and forms amine-functionalized GO. The successful functionalization of GO with amine groups significantly increases its potential applications in catalysis, sensor technology, and filtration, where enhanced interaction with specific analytes or permeants is desired. Overall, step 52 provides GO nanosheets that are tailored for advanced functional applications, providing a platform for further modification and improvement.

The silane agent conforms to a formula of Si(R⁵)_{y}(R⁶)_{z}—[R³—NL]ₓ-R⁴—NH₂. It is a versatile component that plays a role in the design and functionality of advanced materials, particularly filtration membranes. In this formula, R⁵ represents hydrolyzable groups that play a role in the functionality of the silane agent. Each R⁵ can independently be a halogen atom, such as chlorine or bromine, or an alkoxyl group having 1 to 3 carbon atoms, such as methoxy or ethoxy. When exposed to water, R⁵ can undergo hydrolysis, resulting in the release of a byproduct (such as an alcohol in the case of alkoxyl groups) and the formation of silanol groups (Si—OH). The newly formed silanol groups can further condense to create siloxane bonds (Si—O—Si) with adjacent silanol groups and/or with the hydroxyl groups present on the surface of the substrate. This process may lead to a robust network of siloxane linkages that enhance the chemical bonding between the silane agent and the filtration membrane material. As a result, the overall adhesion and stability of the filtration membrane structure are significantly improved, contributing to its mechanical strength and resistance to environmental factors. Additionally, the formation of these siloxane bonds can help mitigate issues such as delamination and degradation over time, thereby enhancing the durability and effectiveness of the filtration membrane in various applications.

Each R⁶ is independently a methyl or ethyl group and affects hydrophobicity and flexibility of the silane agent.

y+z=3. Here, y indicates the number of hydrolyzable groups (R⁵), y is an integer of 1, 2 or 3. z represents the number of alkyl groups (R⁶), z is an integer of 0, 1 or 2. This limitation fosters a diverse array of silane configurations, as varying the proportions of R⁵ and R⁶ allows for tailored modifications of the silane agent's chemical and physical properties. For example, increasing the number of R⁵ groups enhances the agent's ability to form strong chemical bonds with substrates through hydrolysis, promoting better adhesion and stability. Conversely, a higher number of R⁶ groups increases the hydrophobicity and flexibility of the silane.

R³ is a hydrocarbon chain containing 1 to 12 carbon atoms and may further enhance the hydrophobic characteristics of the silane agent, promoting selective permeability in filtration processes. The presence of L, which can be a hydrogen atom, or a single bond connected to a carbonyl group, adds another layer of functionality by influencing the rigidity and interaction of the linking spacer. The integer x, indicating the number of repeating units, allows for modularity in design; when x is 2 or more, each R³ can be independently adjusted, allowing for control over the filtration membrane's hydrophobicity and permeability.

R⁴ is a hydrocarbon group having 1 to 12 carbon atoms. Together, these components can create a sophisticated silane agent that not only improves the mechanical stability and chemical resistance of the filtration membrane but also enhance its performance across a range of separation technologies, making it an essential element in the development of advanced filtration systems.

In some embodiments, the silane agent may include at least one selected from the group consisting of 2-[2-(3-trimethoxysilylpropylamino)ethylamino]ethylamine, N-(2-Aminoethyl)-11-aminoundecyltrimethoxysilane, N-(6-aminohexyl)aminomethyltriethoxy silane, N-2-(aminoethyl)-3-aminopropylmethyldimethoxysilane and N-2-(aminoethyl)-3-aminopropyltrimethoxysilane. In preferred embodiments, the silane agent includes 2-[2-(3-trimethoxysilylpropylamino)ethylamino]ethylamine, noteworthy for its multifunctional amine capabilities. This compound incorporates a trimethoxysilyl group, which can be used for forming strong siloxane bonds with surfaces upon hydrolysis. The three methoxy groups allow for efficient hydrolysis when exposed to moisture, leading to the release of methanol and the formation of silanol groups that can subsequently condense to create durable siloxane networks. The presence of the propylamino group contributes to the molecule's hydrophobic characteristics and introduces amine functionalities, which can engage in additional chemical interactions, such as hydrogen bonding, with other components in the filtration membrane matrix. The ethylamine segments provide further versatility by allowing for enhanced flexibility and adaptability of the silane agent. The strategic arrangement of these functional groups enhances the overall adhesion between the silane agent and the substrate, promoting better stability and durability of the resulting material. By employing 2-[2-(3-trimethoxysilylpropylamino)ethylamino]ethylamine, a user can significantly improve the performance and longevity of filtration membranes, making them more effective in applications such as water treatment, oil separation, and other industrial processes.

At step 54, the method 50 includes dipping the polysulfone (PFS) membrane support in a first solution including the amine-functionalized GO nanosheets and diethylenetriamine (DETA). The duration of the dipping is not particularly limited and for example can be 1-30 minutes, preferably 2-20 minutes, preferably 3-10 minutes, preferably about 5 minutes. Step 54 can enhance the filtration membrane's surface properties and overall filtration performance.

At step 56, the method 50 includes removing the PFS membrane support from the first solution containing amine-functionalized Graphene Oxide (GO) nanosheets and diethylenetriamine (DETA). Upon removal from the solution, the filtration membrane retains a layer of the amine-functionalized GO and DETA on its surface. After removal, an excessive solution on the filtration membrane surface can be wiped or drained away. Step 56 may help ensure that the functionalization process is uniform and that the modified surface is ready for subsequent drying or curing processes. Proper handling during this stage can help prevent damage to the newly functionalized surface, ensuring that the enhanced properties imparted by the GO and DETA are preserved.

At step 58, the method 50 includes contacting the PFS membrane support with a second solution including trimesoyl chloride to form an initial film on the PFS membrane support. Trimesoyl chloride is an aromatic acyl chloride that serves as a tri-functional monomer, enabling the formation of a robust polymeric film through a reaction with the amine groups present on the surface of the filtration membrane, including amine groups from the amine-functionalized Graphene Oxide (GO) nanosheets and diethylenetriamine (DETA). When the PFS membrane is immersed in this second solution, the reactive acyl chloride groups of trimesoyl chloride undergo nucleophilic substitution reactions with the available amine functionalities on the filtration membrane surface. This reaction initiates the formation of amide bonds, effectively anchoring the trimesoyl groups onto the filtration membrane and leading to the development of a polymeric film. This film not only enhances the filtration membrane's structural integrity but also improves its chemical resistance and operational stability. The formation of this initial film creates a barrier that can further modify the filtration membrane's surface properties, such as hydrophilicity and permeability, tailored for specific filtration applications. Additionally, the film contributes to the overall performance of the filtration membrane by providing a platform for subsequent functionalization or modifications if desired.

At step 60, the method 50 includes crosslinking the initial film to obtain the filtration membrane. The crosslinking can be executed at a temperature of about 60° C. for a duration of about 10 minutes. Alternatively, the temperature can be 40-100° C., preferably 50-90° C., preferably 60-80° C. while the duration can be at least 1 minute, preferably 2 to 60 minutes, preferably 5 to 30 minutes, preferably 10 to 20 minutes. Crosslinking refers to the process of creating covalent bonds between straight or linear polymer chains, which improves the structural integrity and stability of the filtration membrane. This is typically achieved through thermal treatment or chemical agents that facilitate further reactions between the amine groups and the acyl chloride functionalities present in the initial film. The crosslinking reaction reinforces the network of amide bonds, resulting in a three-dimensional polymeric matrix that enhances the filtration membrane's resistance to mechanical stress and deformation during operation. This added stability can be beneficial in filtration applications, where membranes are subjected to varying pressures and flow rates. Additionally, crosslinking can improve the filtration membrane's resistance to chemical degradation, ensuring that it maintains its performance over extended periods in diverse operational environments. The crosslinked structure can contribute to improved filtration characteristics by potentially reducing pore size and altering surface morphology, which can enhance selectivity and reduce fouling. Note that some crosslinking may occur at step 58, in which case step 60 can be used to increase a crosslinking density of the filtration membrane.

A filtration membrane includes a polysulfone (PFS) membrane support; and a crosslinked polyamide layer disposed on the PFS membrane support and including a network formed by polycondensation between diethylenetriamine and trimesoyl chloride, and graphene oxide (GO) nanosheets covalently bonded to the network via a linking spacer. Alternatively or additionally, the filtration membrane support may include Polyethersulfone (PES), Polyvinylidene Fluoride (PVDF), Cellulose Acetate (CA), Polyamide (PA), Polylactic Acid (PLA), and Silicone Rubber.

The PFS membrane serves as a robust foundation, providing mechanical strength, durability, and structural integrity. Polysulfone is chosen for its excellent thermal and chemical resistance, making it suitable for a wide range of applications, from water treatment to industrial separations.

Over this PFS support, the crosslinked polyamide layer is formed through a polycondensation reaction between diethylenetriamine and trimesoyl chloride. This reaction results in a network of amide bonds that creates an interconnected polymeric structure. The crosslinking enhances the mechanical properties of the polyamide layer, providing rigidity and stability while also improving its resistance to chemical degradation and physical stress. This network not only strengthens the filtration membrane but also contributes to its selective filtration capabilities.

Graphene oxide (GO) nanosheets are covalently bonded to the crosslinked polyamide network via a linking spacer. This covalent bonding ensures that the GO nanosheets are effectively integrated into the polyamide matrix, enhancing the filtration membrane's functional properties. The GO nanosheets serve multiple roles; they improve the hydrophilicity of the filtration membrane, increase its surface area for interactions with contaminants, and enhance its mechanical strength due to their inherent structural properties. The crosslinked polyamide layer formed during the method incorporates Graphene Oxide (GO) nanosheets interspersed among the polymeric particles, creating a composite material with unique structural and functional properties. The interspersed arrangement of GO nanosheets enhances the overall mechanical strength and stability of the polyamide layer, as the nanosheets act as reinforcing agents, providing rigidity and resistance to deformation. The presence of GO nanosheets within the polyamide matrix contributes to improved permeability and selectivity in filtration applications. The nanosheets create pathways for fluid flow, facilitating better transport while simultaneously increasing the surface area available for interactions with contaminants. This configuration can lead to enhanced separation efficiency, as the unique properties of GO—such as its high aspect ratio and surface functionalization—can be leveraged to selectively capture particles and improve the filtration membrane's fouling resistance. The interspersion of GO within the polyamide layer can enhance the chemical resistance of the filtration membrane, making it more robust against harsh operational conditions. The combination of the polyamide's intrinsic properties and the added functionalities from the GO nanosheets results in a filtration membrane that is not only durable but also highly effective across a range of applications, including water purification, wastewater treatment, and industrial separations. Overall, the crosslinked polyamide layer with interspersed GO nanosheets represents a significant advancement in membrane technology, providing enhanced performance characteristics that meet the demands of modern filtration processes.

The crosslinked polyamide layer can be in the form of the GO nanosheets interspersed among particles. The particles have lateral dimensions ranging from 50 to 300 nm, preferably 100-250 nm, preferably 150-200 nm, while the graphene oxide (GO) nanosheets possess larger lateral dimensions between 100 and 900 nm, preferably 200 to 800 nm, preferably 300 to 700 nm, preferably 400 to 600 nm. The smaller particles, with their 50-300 nm dimensions, enhance the surface area available for interactions with contaminants, thereby promoting effective filtration and reducing fouling. Their smaller size also allows for better dispersion within the matrix, leading to a more uniform distribution throughout the filtration membrane. The larger GO nanosheets, measuring 100-900 nm laterally, contribute structural integrity and mechanical reinforcement to the filtration membrane. Their extensive surface area and unique properties, such as high aspect ratio and functional groups, facilitate strong interactions with water and contaminants, improving the filtration membrane's hydrophilicity and selectivity. The combination of these different lateral dimensions allows the filtration membrane to achieve a balance between permeability and retention of target particles, making it suitable for a variety of applications, including water purification, wastewater treatment, and advanced separation processes. This interplay of sizes ultimately enhances the efficacy and durability of the filtration membrane in real-world applications.

The GO nanosheets are not stacked or stacked by no more than 3 layers. This limited stacking can help maintain the advantageous properties of GO, such as high surface area and enhanced reactivity. When the nanosheets remain primarily unstacked, they facilitate improved accessibility for water and contaminants, which enhances the filtration membrane's filtration efficiency. Additionally, little or no stacking helps to prevent aggregation, ensuring that the nanosheets can effectively disperse within the polymer matrix. This structural arrangement not only contributes to the mechanical strength of the filtration membrane but also enhances its overall performance in various filtration applications, allowing for efficient separation and reduced fouling.

The network within the filtration membrane is constructed through a polycondensation reaction involving diethylenetriamine, trimesoyl chloride, and diethylenetriamine-siloxy functionalized graphene oxide (GO) nanosheets. In this process, diethylenetriamine serves as a bifunctional or trifunctional amine that reacts with the acyl chloride groups of trimesoyl chloride, forming amide linkages that create a robust polymeric network. Concurrently, the diethylenetriamine-siloxy functionalized GO nanosheets contribute to this network by providing additional reactive sites, enhancing the overall connectivity and stability of the filtration membrane structure. The diethylenetriamine-siloxy functionalization of the GO nanosheets introduces —NH₂ and —NH groups that can react with the acyl chloride, promoting the integration of the GO into the polyamide matrix. This dual reactivity ensures that the GO nanosheets are not only incorporated into the network but also contribute to its mechanical properties and chemical resilience. The resulting crosslinked structure improves the filtration membrane's durability and performance, enabling it to withstand various operational conditions while effectively separating contaminants. This synergistic interaction between the components fosters a strong, cohesive membrane with enhanced filtration capabilities, making it suitable for advanced applications in water treatment and industrial separations.

The linking spacer facilitates the connection between the GO and the polyamide network, allowing for controllable distribution of the GO throughout the filtration membrane structure for example by changing the number of backbone atoms of the linking spacer. This integration not only enhances the filtration membrane's filtration efficiency but also reduces fouling, as the unique properties of GO can help repel unwanted particles and contaminants. Additionally, the combination of the crosslinked polyamide with GO nanosheets results in a membrane that exhibits improved permeability and selectivity, making it highly effective for applications such as water purification, gas separation, and other advanced filtration technologies.

Overall, this filtration membrane represents a significant advancement in membrane technology, combining the strengths of both the PFS support and the functionalized polyamide layer, with the added benefits of graphene oxide. The result is a high-performance membrane capable of meeting the rigorous demands of modern filtration applications while ensuring durability and efficiency.

The linking spacer includes a backbone chain having at least 8 backbone atoms. The backbone chain has a plurality of amine groups including —NH— and —NH₂, and the linking spacer is bonded to the graphene oxide nanosheets via a —Si—O— bond and bonded to the network via reactions between trimesoyl chloride and the plurality of amine groups. The linking spacer includes, a flexible backbone made up of various atoms, such as carbon, nitrogen, and/or oxygen. This backbone typically includes at least eight atoms, providing structural versatility. It is often functionalized with reactive groups that enable the spacer to establish covalent bonds with adjacent materials, thus facilitating robust interactions and increase the crosslinking density. The presence of a plurality of amine groups (—NH— and —NH₂) within the linking spacer further amplifies its effectiveness. These amine groups not only foster strong interactions between the GO and the polyamide network but also improve the spacer's chemical reactivity and affinity for water. This hydrophilic character is essential for enhancing the filtration membrane's selective permeability and antifouling characteristics, making it more effective in various filtration applications. Moreover, the flexibility offered by the linking spacer allows it to adapt to the dynamics of the composite, ensuring that stress is evenly distributed across the filtration membrane during operation. This adaptability contributes to the overall mechanical stability and chemical resistance of the filtration membrane, leading to a longer service life and reduced susceptibility to degradation under challenging conditions. Overall, the linking spacer is instrumental in creating synergistic interactions among the different constituents of the composite, resulting in enhanced functionality, durability, and performance in applications such as water purification, wastewater treatment, and gas separation.

In some embodiments, the linking spacer conforms to a formula of *—SiR¹R²—[R³—NL]ₓ-R⁴—NH—** where, * represents one side or one end of the linking spacer bonded to an oxygen atom of the GO nanosheets. This bond establishes a stable connection between the spacer and the GO, facilitating effective integration into the overall membrane architecture. This bond is typically formed through a siloxane or silane linkage, where the silicon atom interacts directly with the oxygen functional groups present on the surface of GO. The oxygen atoms on GO, which are abundant due to its various functional groups such as hydroxyls and epoxides, provide ideal reactive sites for this interaction. Additionally, by anchoring the spacer to the GO, the potential for agglomeration of the nanosheets is reduced, promoting better dispersion and enhancing the antifouling characteristics.

** represents another side or another end of the linking spacer bonded to a carbonyl group of the polyamide network. As a result, —NH—** of the linking spacer and the carbonyl group of the polyamide network form an amide bond. This amide bond enhances the structural integrity of the composite by ensuring that the linking spacer is chemically bonded to the network, which helps distribute stress and prevents delamination during operation. By establishing this connection, the amide bond contributes to the formation of a crosslinked structure that increases the mechanical strength and stability of the filtration membrane. Additionally, this covalent interaction allows for the synergistic enhancement of properties, such as improved resistance to swelling and deformation under various environmental conditions.

R¹ and R² are each independently a hydroxyl group, a methyl group or an ethyl group. The hydroxyl group (—OH) enhances the hydrophilicity of the linking spacer, improving its ability to interact with water and other polar substances. This increased affinity for water is particularly advantageous in filtration applications, as it can help reduce fouling and promote better permeation of liquids through the filtration membrane. On the other hand, the methyl group (—CH₃) introduces hydrophobic characteristics while maintaining a relatively small and non-bulky structure. This can help balance the overall hydrophilicity of the spacer, providing a degree of flexibility in tuning the interaction of the filtration membrane with various solutes. The presence of methyl groups can also enhance the spacer's stability, as they can contribute to steric hindrance that protects reactive sites from unwanted reactions. The ethyl group (—C₂H₅) is hydrophobic and provides a larger, more flexible side chain that can improve the spacer's mechanical properties. The ethyl group can also enhance the overall structural integrity of the linking spacer, allowing for better stress distribution across the filtration membrane. By offering a range of functional and structural options, R¹ and R² allow for the customization of the linking spacer, enabling the fine-tuning of the filtration membrane's properties to improve its performance in specific filtration applications.

In some embodiments, R³ is a hydrocarbon group containing between 1 and 12 carbon atoms, preferably 2 to 8 carbon atoms, preferably 4 to 6 carbon atoms. The length and composition of R³ can vary widely, which allows for tailored hydrophobicity and flexibility in the spacer design. Shorter hydrocarbon groups, such as those with 1 to 3 carbon atoms (e.g., methyl, ethyl, or propyl), tend to impart less hydrophobicity and better water affinity, which is advantageous for improving membrane performance in aqueous environments. Longer hydrocarbon chains (with 4 to 12 carbon atoms) introduce more hydrophobic characteristics, which can help to improve the filtration membrane's resistance to certain solutes and contaminants. These longer chains contribute to the filtration membrane's structural integrity, providing greater mechanical strength and stability during operation. The presence of varying carbon chain lengths within R³ allows for adjusting the filtration membrane's surface properties, effectively tuning its interaction with different feed streams and enhancing selectivity. Additionally, the hydrocarbon nature of R³ can influence the packing density of the linking spacer, affecting the overall morphology of the composite. Hydrocarbon groups can help modulate the balance between hydrophilic and hydrophobic interactions, which is desirable for attaining the desired filtration properties.

L is a hydrogen atom or a single bond connected to a carbonyl group of the network. When L is linked to a carbonyl group of the network, it introduces a crosslinking site and a degree of rigidity to the spacer, which can stabilize the overall structure of the filtration membrane and enhance its mechanical strength.

x is an integer of 1 or more, preferably 2 to 6, preferably 3, 4 or 5. When x is 2 or more, each R³ can be independently chosen, enabling control over the filtration membrane's hydrophobic characteristics, which can be helpful for selectively filtering specific molecules while rejecting others. In some embodiments, x is an integer ranging from 1 to 6. When x is between 2 and 6, each R3 can independently be a hydrocarbon group having 1 to 4 carbon atoms. Furthermore, an increased x can improve the overall mechanical strength and flexibility of the spacer, as the multiple units can distribute stress more evenly across the filtration membrane structure. This modular design approach also contributes to increased surface area, which can enhance permeation rates and improve the efficiency of filtration processes. Additionally, having multiple R³ groups connected through the spacer can facilitate enhanced interactions with the surrounding matrix, further promoting stability and resistance to fouling. Thus, the integer x not only influences the physical attributes of the filtration membrane but also allows for enhancing its functional application across diverse separation technologies.

R⁴ is a hydrocarbon group having 1-12 carbon atoms, preferably 2-8 carbon atoms, preferably 3-6 carbon atoms. In some embodiments, R⁴ is a hydrocarbon group having 1-4 carbon atoms.

In some embodiments, the linking spacer conforms to a formula of *—Si(OH)₂—(CH₂)₃—N(L₁)-(CH₂)₂—N(L₂)-(CH₂)₂—NH—**, where L₁ is a hydrogen atom or a single bond connected to a carbonyl group of the network, and L₂ is a hydrogen atom or a single bond connected to a carbonyl group of the network.

In some embodiments, at least one of L1 or L₂ is a single bond connected to a carbonyl group of the network, which introduces at least one crosslinking site.

Referring back to step 52, a dispersion of GO can be prepared in a solvent such as ethanol by ultrasonication, to achieve a homogeneous mixture of GO nanosheets within the solvent. Ultrasonication employs high-frequency sound waves to create intense agitation in the liquid medium, generating microscopic bubbles that collapse rapidly, a phenomenon known as cavitation. This action helps to break apart any aggregated or stacked GO sheets, effectively dispersing them in the ethanol and enhancing their stability in the dispersion or suspension.

Ethanol is chosen as the solvent due to its excellent solvation properties and compatibility with the polar functional groups present on the GO surface. The use of ultrasonication not only ensures that the GO is evenly distributed but also aids in exfoliating the nanosheets to their monolayer or few-layer forms (e.g. a 2-layer form and a 3-layer form), which is crucial for improving their surface area and functional properties. A well-dispersed GO solution can help ensure uniform interaction with other components in the formulation process, whether for further functionalization, composite material development, or incorporation into membranes. Then, the silane agent can be added to the dispersion of GO to form the mixture.

Still referring to step 52, the refluxing can be executed at a temperature of 80° C. for 12 hours to obtain the amine-functionalized GO nanosheets. Refluxing is a technique that heats the mixture to its boiling point, allowing vapors to condense back into the liquid for continuous interaction between reactants. This sustained heating enhances the chemical reactions between the silane agent and the functional groups on the GO surface, promoting the formation of stable covalent bonds, particularly amine linkages. This reaction results in the formation of amine-functionalized GO nanosheets. Alternatively, the refluxing can be executed at a temperature of 75-90° C., preferably 78-85° C., preferably 80-83° C., for 1-24 hours, preferably 2-12 hours, preferably 4-8 hours.

A filtration method involves passing a mixture of water and one or more organic molecules through the filtration membrane. As the mixture is introduced to the filtration membrane, the unique properties of the crosslinked polyamide layer facilitate selective permeability, allowing water molecules to pass through while effectively retaining the larger organic molecules and contaminants. The amine-functionalized GO nanosheets play a critical role in enhancing the filtration membrane's hydrophilicity and overall filtration efficiency, further ensuring that water can permeate efficiently while reducing fouling.

As water permeates through the filtration membrane, it is collected as a purified water permeate, effectively separating it from the organic molecule(s). The combination of the filtration membrane's structural integrity and the functional characteristics of the GO nanosheets not only promotes high flux rates but also improves selectivity, ensuring that the process remains efficient even under varying pressure conditions. This filtration method is particularly advantageous for applications such as wastewater treatment, where the removal of organic contaminants from water is required. This approach yields high-quality permeate, contributing to effective resource recovery and environmental sustainability.

The organic molecule(s) is not particularly limited. For illustrative purposes, the organic molecule in the present disclosure will be focused on acetaminophen, caffeine, and bisphenol A, each of which presents significant environmental and health concerns. Acetaminophen, widely used as an analgesic and antipyretic, frequently enters wastewater systems through pharmaceutical disposal and human excretion. Its persistence in aquatic environments can disrupt the endocrine systems of wildlife and lead to toxicological effects. Caffeine, another prevalent contaminant, is commonly found in wastewater due to its high consumption rates in beverages. While not typically toxic, caffeine's presence in water bodies can indicate the presence of other contaminants and affect aquatic organisms' behavior and reproduction. Bisphenol A (BPA), a chemical used in the production of polycarbonate plastics and epoxy resins, is known for its endocrine-disrupting properties, raising concerns over its impact on human health and wildlife. BPA can leach into water sources from plastic waste and manufacturing processes, leading to widespread contamination.

The filtration membrane's design, which incorporates amine-functionalized graphene oxide nanosheets, enhances its ability to selectively retain these organic molecules while allowing water to permeate. The strong interaction between the functional groups on the filtration membrane and the organic molecules facilitates effective adsorption and removal, ensuring high efficiency in the purification process. By effectively separating these harmful contaminants from water, the filtration method contributes to environmental protection and public health, making it a useful tool for addressing the challenges posed by emerging pollutants in water sources.

The filtration membrane's performance is notably enhanced by the incorporation of graphene oxide (GO) nanosheets and a linking spacer, particularly in its ability to reject organic molecules such as caffeine. This filtration membrane exhibits a rejection efficiency that is at least 10%, preferably 15%-80%, preferably 20%-50%, preferably approximately 20% higher than that of a first comparative membrane, which is the same as the filtration membrane but lacks both the GO nanosheets and the linking spacer. The presence of GO nanosheets significantly improves the filtration membrane's selectivity and adsorption capacity, allowing for more effective interaction with caffeine molecules and enhancing overall filtration performance. The linking spacer also contributes to this efficiency by facilitating better integration of the GO into the polymeric matrix, creating additional pathways for the rejection of contaminants.

A second comparative membrane, which is the same as the filtration membrane but does not include the GO nanosheets, achieves a rejection efficiency that is about 8% higher than the first comparative membrane. This indicates that while the second membrane benefits from certain design features, it still falls short of the filtration efficiency provided by the inclusion of GO nanosheets. The results demonstrate the critical role of both the GO nanosheets and the linking spacer in improving rejection efficiency, underscoring the innovative design of the filtration membrane as a superior solution for effectively removing caffeine and potentially other organic pollutants from water. This enhanced performance not only improves water quality but also highlights the filtration membrane's potential for various applications in water treatment and environmental remediation.

The filtration membrane demonstrates a remarkable rejection efficiency of bisphenol A (BPA) that is at least 20%, preferably 25%-100%, preferably 30%-50%, preferably approximately 30% higher than that of the first comparative membrane. This significant enhancement in performance can be attributed to the unique properties of the GO nanosheets, which provide a high surface area and increased adsorption sites, allowing for stronger interactions with BPA molecules. The functional groups present on the GO enhance hydrophilicity and promote effective capture of BPA, a compound known for its endocrine-disrupting effects. Additionally, the linking spacer plays a role in enhancing the integration of GO nanosheets into the polymeric matrix of the filtration membrane. By facilitating the formation of a stable and cohesive network, the linking spacer ensures that the GO nanosheets are well-distributed and effectively engaged in the filtration process. This combination of advanced materials and structural design not only enhances the filtration membrane's selectivity for BPA but also improves its overall mechanical strength and durability. Consequently, this innovative filtration membrane stands out as a highly effective solution for removing BPA from water sources, addressing critical environmental concerns while ensuring safer water quality for human and ecological health. The 30% improvement in rejection efficiency highlights the significant impact of incorporating GO and linking spacers in developing advanced filtration technologies.

The filtration membrane achieves a water flux rate that is at least 10%, preferably 15%-100%, preferably 20%-50%, preferably approximately 25% higher than that of the first comparative membrane. This enhanced water flux can be primarily attributed to the unique properties of the GO nanosheets, which not only provide a larger surface area but also create more efficient pathways for water transport. The nanosheets facilitate increased interaction with water molecules, allowing them to flow more freely through the filtration membrane structure. Moreover, the presence of the linking spacer improves the spatial arrangement of the GO within the polymer matrix, preventing excessive stacking and ensuring that the nanosheets remain well-dispersed. This effective dispersion reduces potential obstruction to water flow, further contributing to the overall increase in flux. The combination of these factors results in a filtration membrane that not only performs exceptionally well in rejecting contaminants but also allows for higher volumes of water to pass through more quickly. As a result, this membrane stands out as a highly efficient option for applications requiring rapid filtration and high permeability, making it particularly valuable in water treatment processes and other industrial applications where both quality and quantity of permeate are critical. The 25% improvement in water flux highlights the significant benefits that the integration of GO and linking spacers brings to membrane technology.

Adjusting the length of the linking spacer in the filtration membrane plays a role in modifying both the flux rate and permeability. A longer linking spacer can enhance the spacing between graphene oxide (GO) nanosheets, increasing the effective surface area for water flow and thereby improving permeability and flux rate. This configuration allows water molecules to pass through more easily. However, if the spacer is excessively long, it may introduce flow resistance, potentially reducing flux. Conversely, a shorter linking spacer can lead to denser packing of the nanosheets, enhancing contaminant rejection but possibly limiting water permeability. By fine-tuning the spacer length, membrane performance can be tuned to achieve a desirable balance between high water flux and effective contaminant removal, catering to specific filtration needs.

### EXAMPLES

The following examples illustrate a thin-film nanocomposite membranes incorporating functionalized graphene oxide nanosheets. The examples are provided solely for illustration and are not to be construed as limitations of the present disclosure, as many variations thereof are possible without departing from the spirit and scope of the present disclosure.

### Example 1: Experimental: Materials

The starting monomers, trimesoyl chloride (TMC) and diethylene triamine (DETA) of reagent grade were purchased from Sigma Aldrich, Inc. The polysulfone (PSf) membranes to be used as the support layer were purchased from Sterlitech, Inc. The pharmaceuticals and organic analytes were purchased from Sigma Aldrich, Inc. with lab-grade purity. The major relevant characteristics of the compounds are presented in Table 1. Acetaminophen (ACT), caffeine (CFN), bisphenol A (BPA) and amitriptyline HCl (ATT HCl) are shown as organic micropollutants merely for illustrative purposes and are not limiting.

TABLE 1
Relevant properties of the emerging organic
micropollutants used in this study.

| | Acetamin- | | | Amitriptyline |
|---|---|---|---|---|
| | ophen | Caffeine | Bisphenol | HCl |
| Characteristics | (ACT) | (CFN) | A (BPA) | (ATT HCL) |
| Molar weight | 151.17 | 194 | 228.29 | 313.9 |
| (g/mol) | | | | |
| Solubility (mg/L) | 1.4 × 10⁴ | 2.16 × 10⁴ | 600 | 9.7 |
| Log Kow | 0.49 | 0.07 | 3.32 | 4.92 |
| pKa | 9.5 | 5.3-14 | 9.6 | 9.5 |
| Molecular | 0.32 | 0.36 | 0.38 | 0.56 |
| radius (nm) | | | | |
| Molar vol. | 121 | 133.9 | 199.6 | 257.8 |
| (cm³/mol) | | | | |
| Surface Charge | Neutral | Neutral | Neutral | Neutral |

Caffeine is a popular central nervous system stimulant and found in daily consumables such as tea and coffee. Approximately 5% of ingested caffeine is excreted through the urine as it cannot be completely metabolized. In addition, studies have reported higher caffeine concentrations in water resources than in water treated in wastewater treatment plants. Caffeine and other substances were also found in water, sediment, soil, and plants in an area located in Saudi Arabia, with caffeine concentrations up to 20.7 μg·L⁻¹ in the water.

### Example 2: Synthesis of Amino-Silane Functionalized Graphene Oxide

Graphene oxide functionalized with the 2-[2-(3-Trimethoxysilylpropylamino) ethylamino]ethylamine. 1 mg/ml of graphene oxide dispersion was prepared in 50 mL of ethanol. The uniform dispersion of graphene oxide in ethanol was prepared by ultrasonication. The graphene oxide solution was transferred into a round bottom flask, and into the graphene oxide solution, 2-[2-(3-Trimethoxysilylpropylamino)ethylamino]ethylamine was added dropwise under a continuous stirring to get a final concentration of 0.1 M. The round bottom flask was placed in the oil bath and continuously refluxed for 12 hours at a temperature of 80° C. After 12 hours, the heating stopped, and the graphene oxide solution was stirred for a few hours. The amino-silane functionalized graphene oxide was centrifuged and washed several times with ethanol. After washing, the amino silane functionalized graphene oxide is stored at room temperature for further utilization in preparing the thin film nanocomposite (TFN) membranes.

### Example 3: Fabrication of Membranes

The polysulfone support was synthesized according to our previously reported methods, as disclosed in Baig et al. 2024 (Incorporating functionalized graphene oxide into diethylene triamine-based nanofiltration membranes can improve the removal of emerging organic micropollutants, Journal of Colloid And Interface Science, 676, 657-669) and Arshad et al. 2023 (Synthesis of a novel next-generation positively charged polymer and its in-situ grafting into thin film composite membranes to enhance the performance for desalination, Process Safety and Environmental Protection, 178, 34-35), both of which are incorporated herein by references in their entirety. 5 mL of the 1 mg/mL of the non-functionalized graphene oxide or 151 amino-silane functionalized graphene oxide, was added into the 100 mL flask, which consisted of 2% (w/v) diethylenetriamine and 3% (w/v) Triethylamine (TEA). The amine-containing solution is called an aqueous solution (Solution A), a monomer that participates in interfacial polymerization. The non-functionalized graphene oxide or amino-silane functionalized graphene oxide containing amine solution was kept in ultrasonication for 1 hour to get a good dispersion of the graphene oxide sheets. The 0.2% (w/v) solution of the trimethyl chloride was prepared in the hexane, and it is usually called nano-aqueous solution and named solution B. The synthesized polysulfone support was dipped into solution A for 5 min. The PSf support was removed from Solution A, and the rubber roller was used to wipe excessive Solution A from the filtration membrane surface. After that, the 0.2% TMC solution was poured on the surface of the PSf support for 60 seconds. During this time, interfacial polymerization took place, forming a thin polyamide active layer on the PSf support. After that, the filtration membrane surface was thoroughly washed with hexane and placed in the oven at 60° C. for 10 minutes to strengthen the cross-linking further. The pristine TFC membrane was prepared similarly, except that the aqueous solution did not present the non-functionalized graphene oxide or amino-silane functionalized graphene oxide. All the polyamide membranes were stored in water for experimental and performance evaluation. FIG. 1B shows the structure of the polyamide active layer of the TFN membrane.

### Example 4: Membrane Characterization

The synthesized membranes were then characterized for relevant surface properties such as wettability, morphology, roughness, and surface charge. A drop shape analyzer (DSA25, Kruss Inc.) was used for the contact angle measurements. Rectangular strips of dimensions 1 cm×4 cm were cut from the membrane sheets and taped onto transparent glass slides. The samples were placed flat onto the stage, and approximately 10 μL of water droplets ejected from a syringe. The contact angles were measured in the sessile mode using the tangential method of the instrument software. Readings were taken from at least 5 different locations, and the average value was calculated. In addition, images of the water droplets on the membrane surface were also captured. A scanning electron microscope (JEOL Instruments) was used to analyze the surface morphology of the membranes. Small 1 cm×1 cm coupons were cut and fixed onto the metallic sample holder using conducting tape. To make the samples conduct, a thin gold film was sputter deposited for 10 minutes. The entire sample area was scanned, and images were taken at the following magnifications: 1,000, 2,500, 5000, and 10,000. In addition, energy dispersive X-ray (EDX) analysis was also performed at selected locations to estimate the surface elemental composition. The surface topography was investigated using a bench-top Atomic force microscope (Nanosurf). Specimens similar in geometry to the one used for contact angle were analyzed. The laser was aligned, and the cantilever height was adjusted. A prescan was conducted to assess the feasibility of the selected region for the actual scan. A scan area of 10 μm×10 μm was selected, and the scan speed was set to 0.8 lines/second. 3-D images were generated, and the scale was adjusted to obtain the most reasonable height for the peaks. Area and line roughness were calculated by the machine software.

### Example 5: Filtration Performance

The filtration behavior of the membranes was investigated with an all-in-one membrane testing skid (Sterlitech, Inc.). This included three CF042 membrane cells connected to one another in a parallel configuration and connected to the feed tank by a series of Teflon tubes and stainless-steel pipes. The conical-shaped feed tank with a total capacity of ˜30 liters had circular coils inside connected to a Cole-Parmer recirculating chiller to maintain a constant feed temperature. A high-pressure pump (Wanner Engineering) was connected to the feed tank from one side and to the membrane cells from the other. The equipment was operated by a touchscreen control panel that displayed the feed side, concentrate side pressure, and the feed flow rate.

The membranes were immersed overnight in de-ionized (DI) water before the filtration studies. After the commencement of the experiment, the membranes were compacted at a pressure 50-100 psi higher than the working pressure for 2-3 hours. The pressure was adjusted to ˜215 psi (almost 15 bars), and the system stabilized. After removing air bubbles from the permeate tube, the permeate from each cell was collected in separate plastic 50 ml vials for 10 min. The flux was calculated using the standard equation

$$VJ = Axt$$

Where J is the flux in LMH
V is the volume of permeate in liters
A is the active membrane area in m2
t is the time of permeate collection in hours.

### Results & Discussion

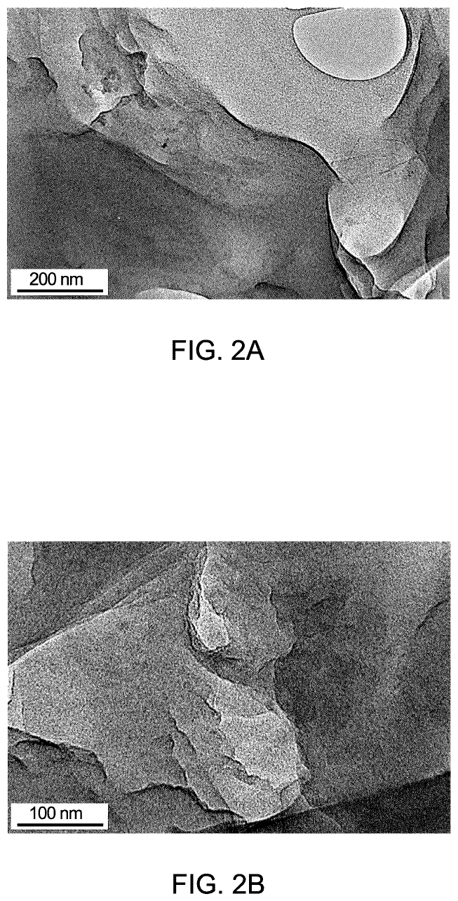

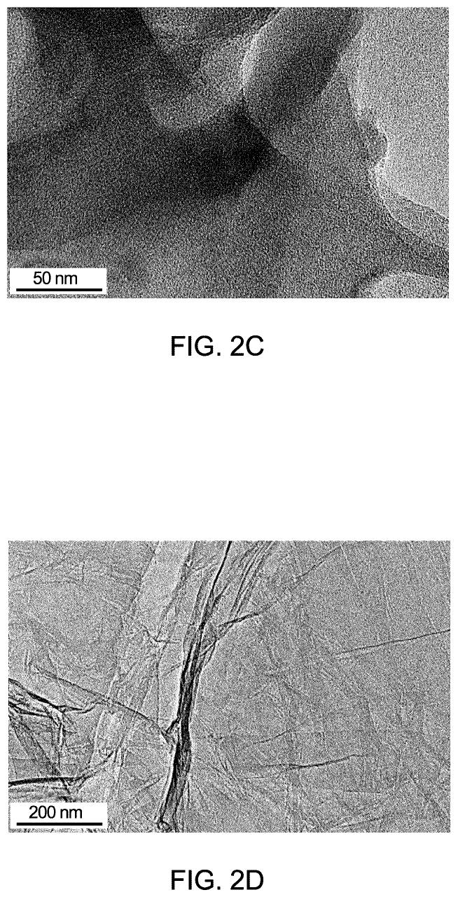

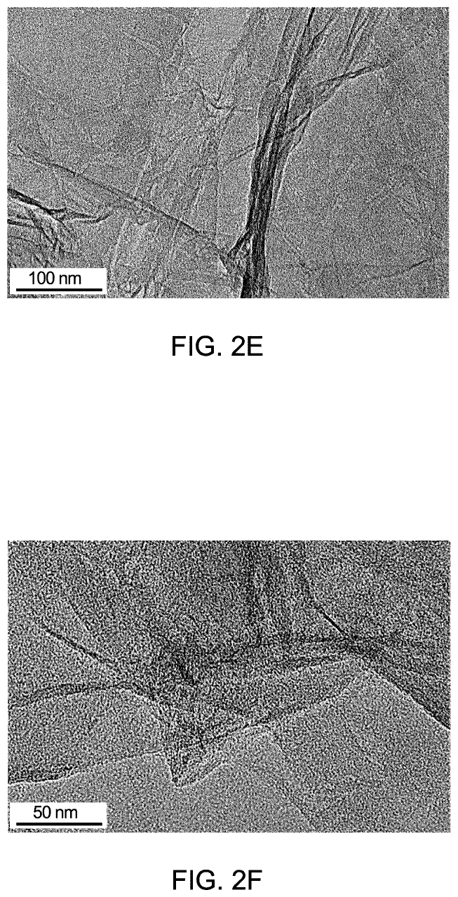

TEM analysis of the graphene oxide and the amino-silane functionalized graphene oxide was performed to observe the surface morphology (FIG. 2A-FIG. 2F). The TEM analysis shows that graphene oxide has a sheet structure, and the stacking of the sheets is more evident without functionalization.

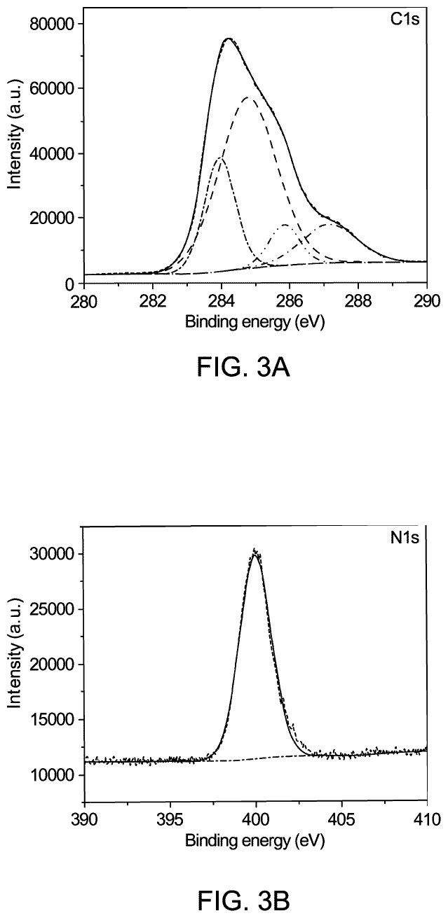

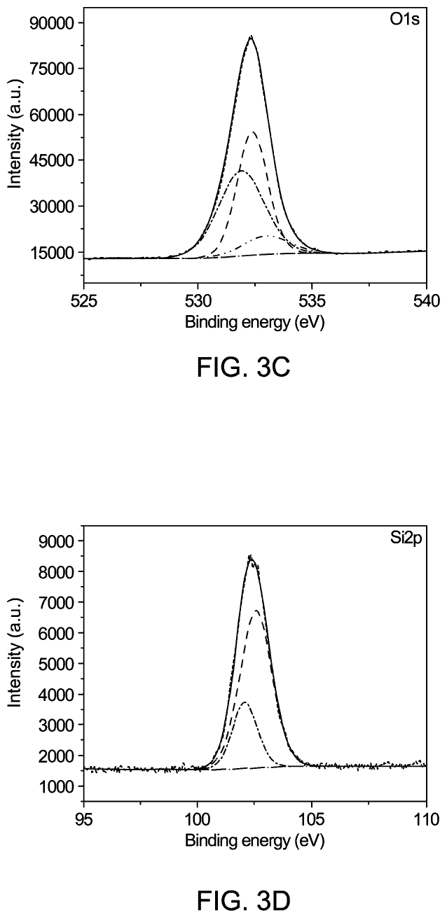

The XPS analysis of the amino-silane functionalized graphene oxide was performed to analyze the successful functionalization (FIG. 3A-FIG. 3D). The high-resolution deconvoluted C1s spectra revealed the presence of binding energies at 283.97, 284.8, 285.84, and 287.16 eV. These binding energies can be assigned to C—Si, C—C, C—O/C—N, and O—C═O. The N1s spectrum has shown the binding energy at 400.05 eV. The deconvoluted O 1s spectra have shown the peaks at the binding energies of 531.91, 532.38 eV, and 533 eV can be assigned to the Si—O, C—O, and H—O—C═O, respectively. The deconvoluted spectra of Si 2p have shown the binding energies at 102.08 and 102.55 eV, which can be assigned to Si—C and Si—O, respectively.

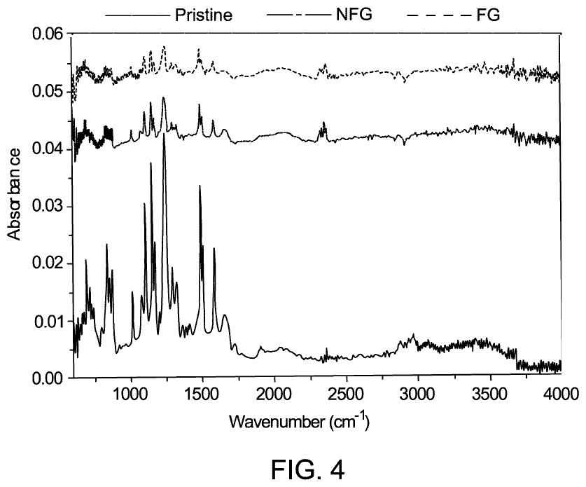

Incorporating nanofillers in the polyamide active layer changes the surface chemistry of the membranes. These changes are typically detected using FTIR spectroscopy. FIG. 4 shows Fourier Transform Infrared (FTIR) spectra for three membranes: the pristine polyamide, the one incorporating GO without functionalization noted as NFG, and the membrane with functionalized GO noted as FG. It is observed that all the spectra show the characteristic peaks emanating from the PA active layer and the PSf support layer in the footprint region 1,500-1,700 cm⁻¹: a twin peak around 1,500 cm⁻¹, a sharp peak ˜1,585 cm⁻¹ (polysulfone) and a broader one with less intensity at approx. 1,665 cm⁻¹. This pattern is somewhat different from regular polyamide membranes, which comprise m-phenylene diamine as one of the starting monomers. The membranes synthesized with MPD typically have peaks ˜1,540 and 1,609 cm⁻¹ corresponding to amide II and amide I bands, respectively. One difference is that a small peak of ˜1,730 cm⁻¹, probably ascribed to the carbonyl group, is not visible in the modified membranes. Also, the intensity of the other peaks is significantly reduced for the NFG and FG membranes.

Another difference is the emergence of more intense peaks in the region 2,300-2,400 cm⁻¹. A twin peak is prominent for both the NFG and FG membranes, whereas it is virtually absent in the pristine polyamide. This may be attributed to the abundant —OH and —COOH groups on the graphene oxide particles. Also, the broad peak centered around 3,300 cm⁻¹ prominent in the pristine spectra, is almost flattened in the modified membranes spectra.

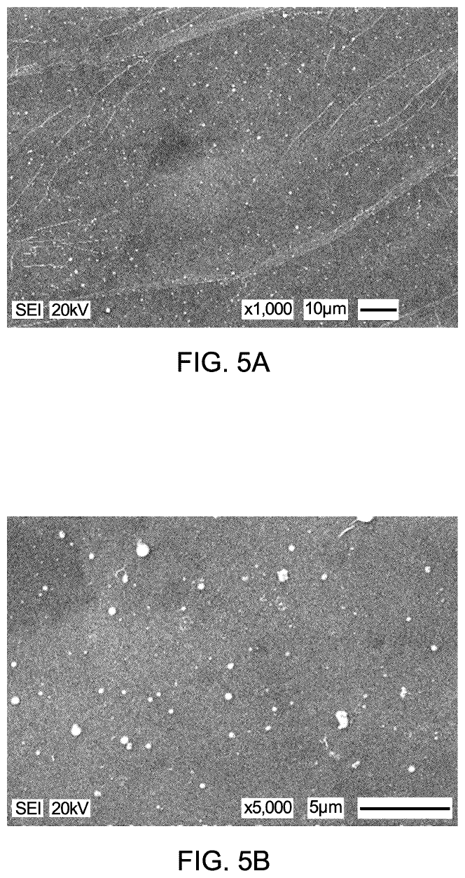

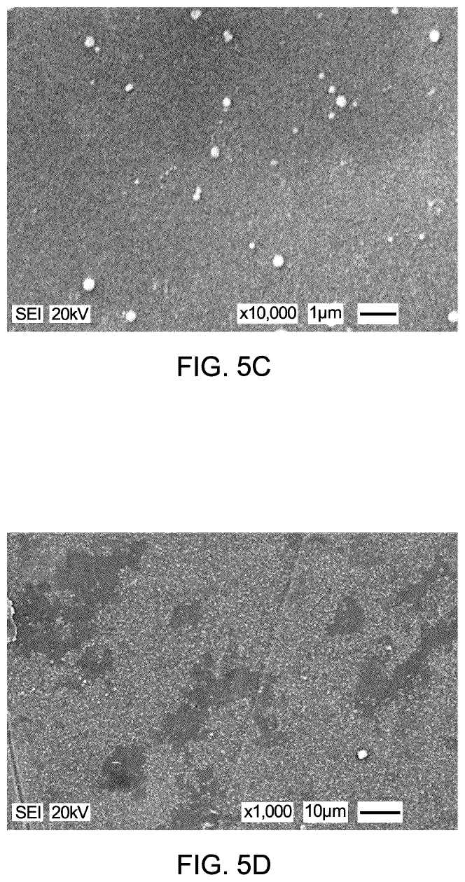

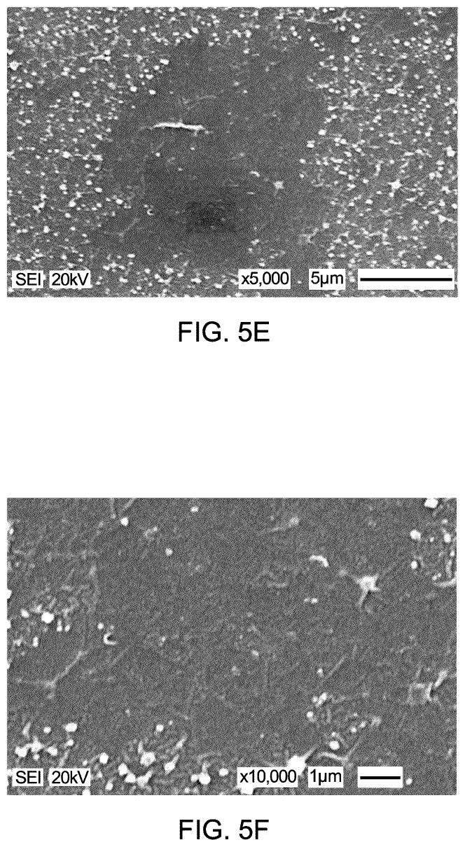

FIGS. 5A-5F shows some representative SEM images for three membranes. The membrane surface with the regular polyamide appears smooth with the sporadic presence of spherical particles (FIGS. 5A-5C). A similar morphology was observed for XN45, a commercial NF membrane used for dairy wastewater treatment. In this work, diethylene triamine was used as the monomer to react with trimesoyl chloride (TMC) for the IP reaction. It is possible that some agglomeration of the monomers took place, resulting in the sporadic formation of particles.

The SEM images of the modified membranes show a more uniform presence and homogeneous distribution of particles (FIG. 5D). However, the more relevant and distinguishing feature of these images is the presence of a sheet-like structure (FIGS. 5E-5F). These sheets are clearly seen in the higher magnification images, with the lines and boundaries visible.

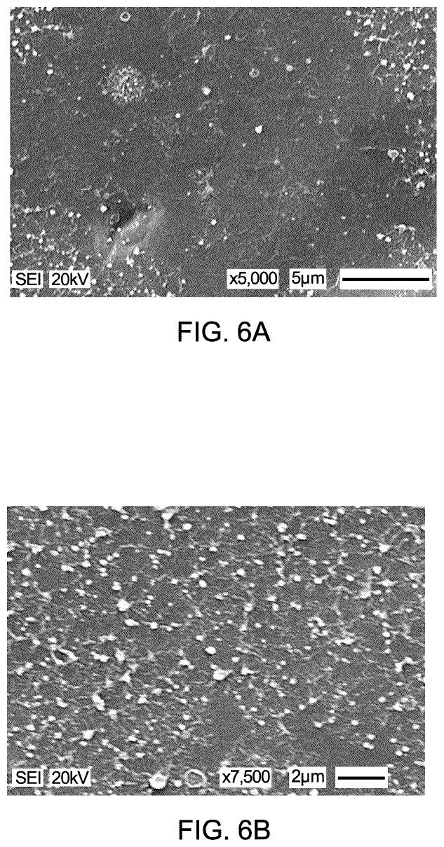

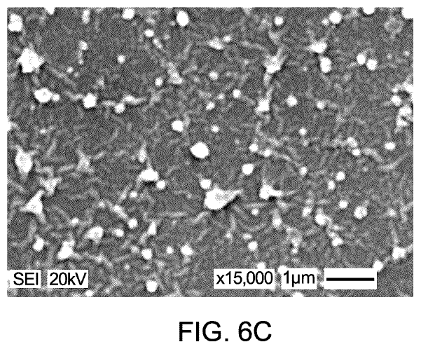

The sheet-like structure is also visible in regions with particles. FIGS. 6A-6C are SEM images at different magnifications showing the sheet network interspersed among the particles. It is observed that the particles lie on top of the sheets, which is a good indicator of the GO layer being right next to the membrane surface. This is the desired configuration as it imparts the necessary characteristics, such as hydrophilicity antifouling, to the membrane.

The surface roughness of membranes may affect the filtration performance and fouling behavior. Rougher surfaces have higher permeated flux due to the increased surface area with which the feed water comes into contact. However, the downside is that higher roughness results in greater fouling susceptibility due to a higher probability of foulant particle deposition in the valleys. Also, it is difficult to dislodge or remove the foulants once deposited, even with very high shear forces. Due to the nature of the interfacial polymerization reaction, the formed polyamide layer has peaks and valleys, resulting in roughness at the nanometer scale. Typically, the presence of nanoparticles further increases the roughness because they act as projections on the surface.

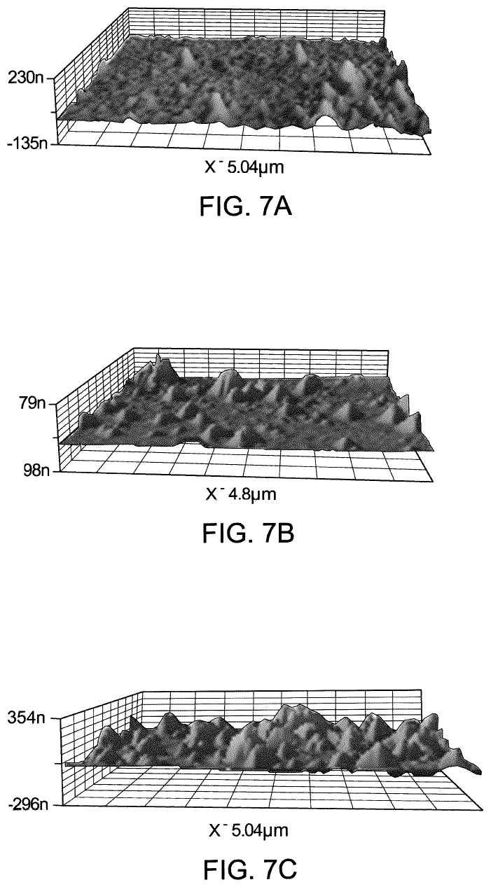

FIGS. 7A-7C show some representative AFM images for the different membranes. The pristine membrane has a smooth surface with very small peaks and valleys and an average roughness of ˜15 nm (FIG. 7A). Similar roughness values have been observed for commercial NF membranes such as HL-TFC, XN45, and NFW. The GO-modified membranes have a higher average roughness due to the presence of small peaks in the location of GO nanosheets (FIG. 7B-FIG. 7C). A similar phenomenon has been observed for other nanofillers, e.g., SiO₂ and TiO₂ nanoparticles on the membrane surface.

Among the modified membranes, the membrane with functionalized GO nanosheets in the active layer has higher roughness (˜30 nm) than the one with pristine graphene oxide (˜20 nm). Moreover, the peaks in the former are evenly spaced throughout the surface as opposed to the nonuniform distribution in the NFG membrane (FIG. 7B). The FG membrane's higher roughness and more uniform profile (FIG. 7C) are explained as follows: an oxide nanosheet has OH groups both on the top and bottom, forming bonds with the silane. The long alkyl chain of the silane connects the sheet to the main polyamide network on both sides, resulting in the GO nanosheets being stacked between the consecutive PA chains. The active layer of this membrane consists of stacked sheets at regular intervals. In contrast, the pristine oxide nanosheets in the NFG membrane are more likely to be clumped together.

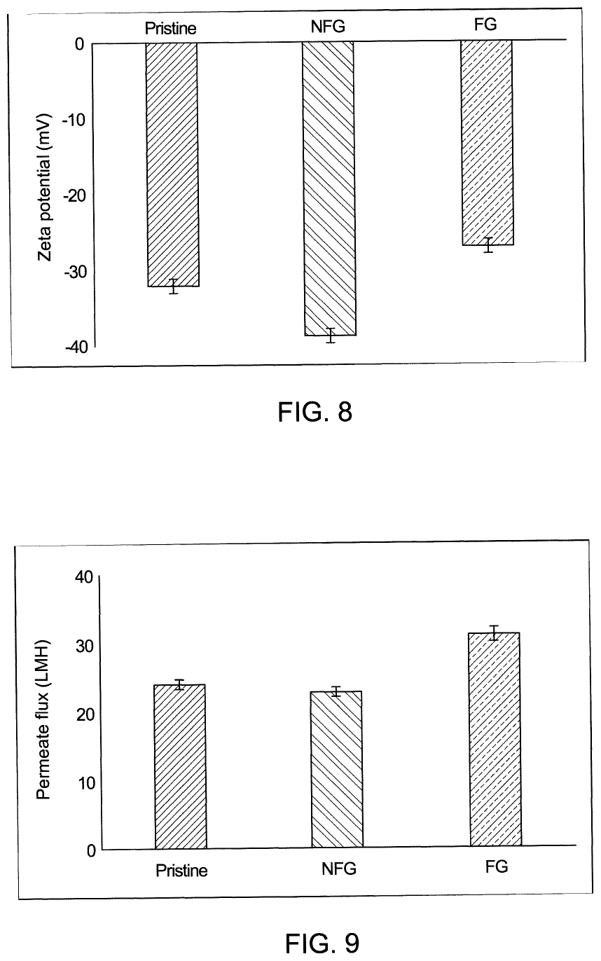

Similar to roughness, the surface charge influences filtration behavior, particularly the rejection of solutes due to electrostatic interactions with the membrane surface. For instance, a negatively charged membrane will strongly repel organic solutes with a negative charge and vice versa. FIG. 8 shows the average zeta potential values for the three membranes at a neutral pH. The pristine membrane has a value of ˜−32 mV, consistent with that found in the literature. At a pH of ˜7, most carboxylic (COO—) groups on the polyamide are deprotonated. Hence, the surface has a high negative charge.

When non-functionalized GO particles are incorporated into the active layer, the surface becomes more negatively charged, as verified by a zeta value of ˜−38.7 mV. The structure of graphene oxide has abundant functional groups, e.g., hydroxyl and carboxylic groups. At a pH of ˜7, a high proportion of these moieties become ionized and are negatively charged. However, functionalization of the oxide particles with Si and N—H groups shifts the surface charge towards a less negative value, ˜−27.1 mV. This can be explained by the presence of extra amines connected to the graphene oxide molecules in the NFG membrane. The amines are usually protonated at a neutral pH and have a positive charge. Although amine groups are also present on the surfaces of pristine and NFG membranes, they are fewer. The extra amines due to the functionalization of GO particles compensate for the negative charge from carboxylic groups to a larger extent. In a recent study, Jeyeseelan and co-workers prepared amine-functionalized graphene oxide to enhance fluoride ions' removal. They observed that functionalization improved the adsorption of the negatively charged F⁻ as it interacted more with the protonated amines. [Jeyaseelan, A., Ghfar, A. A., Naushad, M., Viswanathan, N., 2021. Design and synthesis of amine-functionalized graphene oxide for enhanced fluoride removal. J Environ Chem Eng, 105384, incorporated herein by reference in its entirety].

One advantage of using thin-film nanocomposite membranes for water treatment is permeate flux enhancement. This was first shown around 15 years ago by Hoek and co-researchers, who incorporated zeolite particles in the polyamide layer and observed a significant increase in the permeate flux of polyamide RO membranes. Since then, researchers have experimented with a wide array of nanofillers, such as graphene oxide, silica, titania, MOFs, etc., and obtained promising results with regard to membrane performance [Jeong, B. H., Hoek, E. M. V., Yan, Y., Subramani, A., Huang, X., Hurwitz, G., Ghosh, A. K., Jawor, A., 2007. 576 Interfacial polymerization of thin film nanocomposites: A new concept for reverse osmosis 577 membranes. J Memb Sci 294, 1-7].

FIG. 9 shows the average permeate flux values for the three membranes at a pressure of ˜200 psi (14 bars) and a feed temperature of 24° C. The pristine membrane with the regular polyamide layer has a flux of ˜24 LMH under these conditions. Incorporating GO particles without functionalization does not affect the permeability, and the flux decreases slightly to ˜22.5 LMH. The somewhat reduced permeability can be explained by the presence of the particles as aggregates, which, instead of providing selective nanochannels for water passage, result in increased hydraulic resistance.

In contrast, the flux increased by ˜25% when the polyamide layer was incorporated with functionalized graphene oxide. The presence and optionally uniform distribution of GO nanoparticles in the active layer create nanochannels at intervals through which the water molecules pass relatively easily. This is because the water molecules can form hydrogen bonds with the oxygen atoms of the GO surface, and the water molecules undergo a friction-free slip under the action of hydrogen bonds. Furthermore, molecular simulation has predicted that two-dimensional channels could be formed between stacked GO nanosheets, allowing water molecules to pass through while rejecting solutes, leading to an extremely high perm-selectivity in the nanofiltration process. The improved permeability can also be ascribed to the enhancement of the interfacial polymerization and lowering of the amine monomer diffusivity due to hydrogen bond formation between the well-dispersed functionalized graphene oxide in the polyamide active layer with the diethylene triamine. The resulting polyamide layer is thin and cross-linked, resulting in higher permeability and better rejection of emerging organic contaminants.

Nowadays, organic compounds from various sources, e.g., pharmaceutical compounds, personal care products, pesticides, etc., have been detected in various water sources, including drinking and potable water. Due to their harmful effects on human health and the environment, their removal with high efficiency from wastewater effluent is highly essential. An important aspect of the present disclosure is investigating the removal efficiency of some common and problematic organic micropollutants using TFN membranes. One reason for designing the TFN or advanced membranes is that the conventional TFC membranes either failed or demonstrated lower separation performance, specifically when these membranes deal with neutral organic contaminants. Several studies have reported the lower rejection of the pristine TFC membranes while dealing with emerging organic contaminants. However, the exact reason or mechanism for the low performance or rejection of the NF/RO membrane while dealing with trace organic compounds is unclear, and an in-depth investigation is required. The TFN membranes are the next generation of membranes that improve the performance of NF/RO membranes, removing organic contaminants from water more effectively.

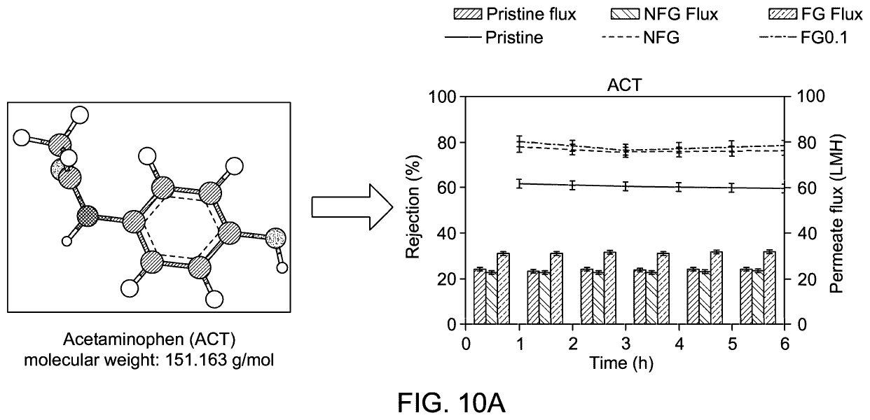

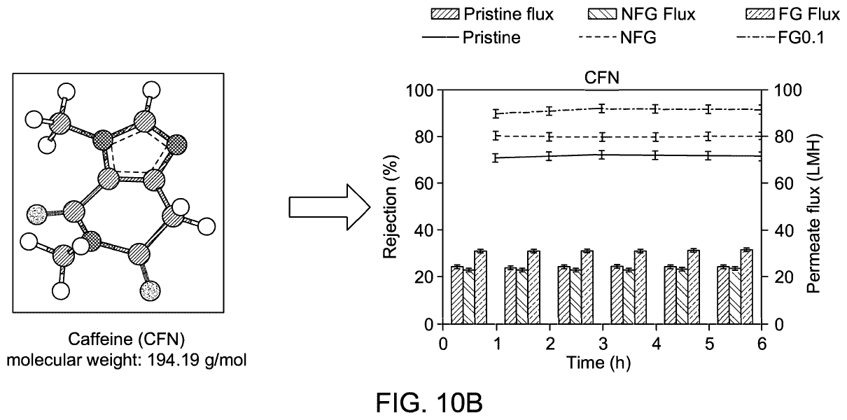

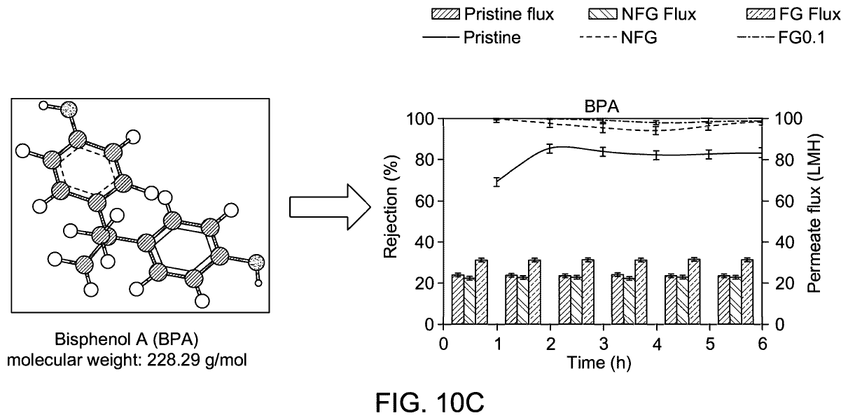

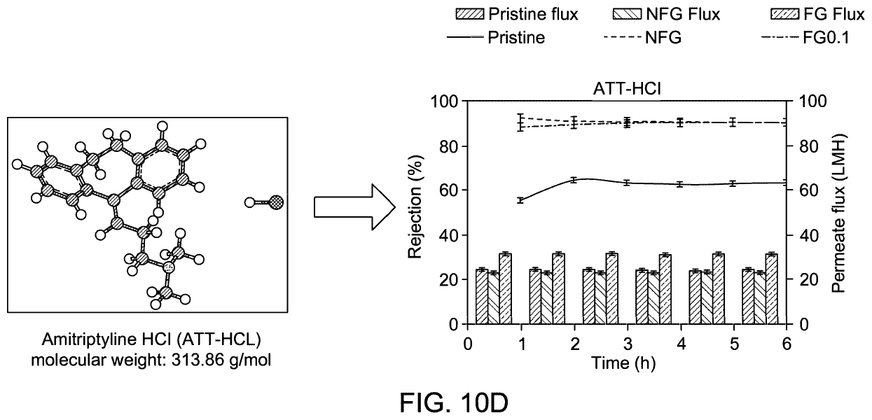

FIGS. 10A-10D show the rejection of the OMPs by the in-house synthesized membranes at an operational pressure of ˜15 bars, a near-neutral feed pH, and a flow rate of ˜5 L/min. The above rejection values were obtained after 6 hours of continuous operation at a feed concentration of ˜10 ppm. The modified membranes remove a significantly higher proportion (e.g. 20-30%) of the organic molecules for all the compounds tested than the pristine TFC membrane. The rejection pattern for both membranes follows the MW pattern i.e. ACT<CFN<BPA, except ATT HCl.

The results in FIGS. 10A-10D are promising for the GO-modified membranes, in particular, the high rejections of compounds with small molecules: Acetaminophen (˜80%) and Caffeine (>90%). These compounds have molar volumes of 121 and 133.9 cm³/mol and molecular radii of only 0.32 nm and 0.36 nm, respectively. The molecular radii are only slightly larger than the average radial pore size of conventional polyamide RO membranes, which is around 0.3 nm. Moreover, both are hydrophilic, leaving little room for hydrophobic interactions with the aromatic groups on the polyamide active layer. On top of that, they are electrically neutral, which implies that electrostatic interactions with the membrane surface have a limited influence on the removal efficiency. In water solutions, these compounds are solvated and consequently, their effective diameter becomes larger. Therefore, they can be rejected more effectively by steric effects.

These rejection levels are comparable to or even better than commercial RO membranes observed in other studies. In a recent study, Shah et al. investigated the effects of water matrix on removing ionic pharmaceutical compounds by commercial NF and RO membranes [Shah, I. A., Ali, S., Yang, Z., Ihsanullah, I., Huang, H., 2022. Effects of water matrix on the rejection of neutral pharmaceutically active compound by thin-film composite nanofiltration and reverse osmosis membranes. Chemosphere 303, 135211]. They observed that the removal efficiency of acetaminophen remained below 70% for both membranes at a neutral pH. This was despite the fact that the MWCO for the RO membrane was reported to be ˜95 Da only, which is much lower than the MW of ACT. In another study, Comerton and co-workers, observed around 82% rejection of ACT with the X20 membrane when using raw lake water as the feed [Comerton, A. M., Andrews, R. C., Bagley, D. M., Hao, C., 2008. The rejection of endocrine disrupting and pharmaceutically active compounds by NF and RO membranes as a function of compound and water matrix properties. J Memb Sci 313, 323-335]. Similarly, Radjenovic et al. removed ˜85% of this compound with the brackish water RO membrane BW30LE when studying the rejection of pharmaceuticals in drinking water [Radjenović, J., Petrović, M., Ventura, F., Barceló, D., 2008. Rejection of pharmaceuticals in nanofiltration and reverse osmosis membrane drinking water treatment. Water Res 42, 3601-3610]. However, one significant difference is that both these groups used a very low concentration feed (e.g. 0.05-1.0 μg/L). Likewise, the removal efficiency for CFN is high (˜91%) for the membrane with functionalized GO nanosheets. A very popular central nervous system stimulant, caffeine is very hydrophilic (log Kow<0) and has a molecular weight of <200 g/mol. Due to its nonionic nature, the most likely removal mechanism is size exclusion.

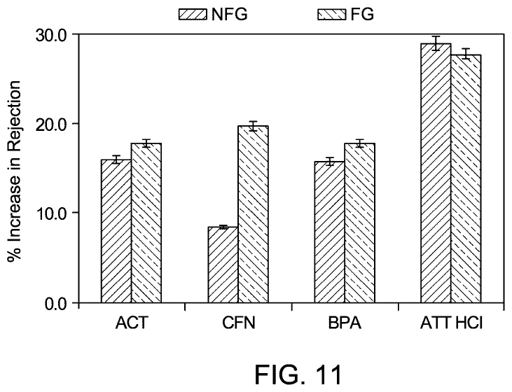

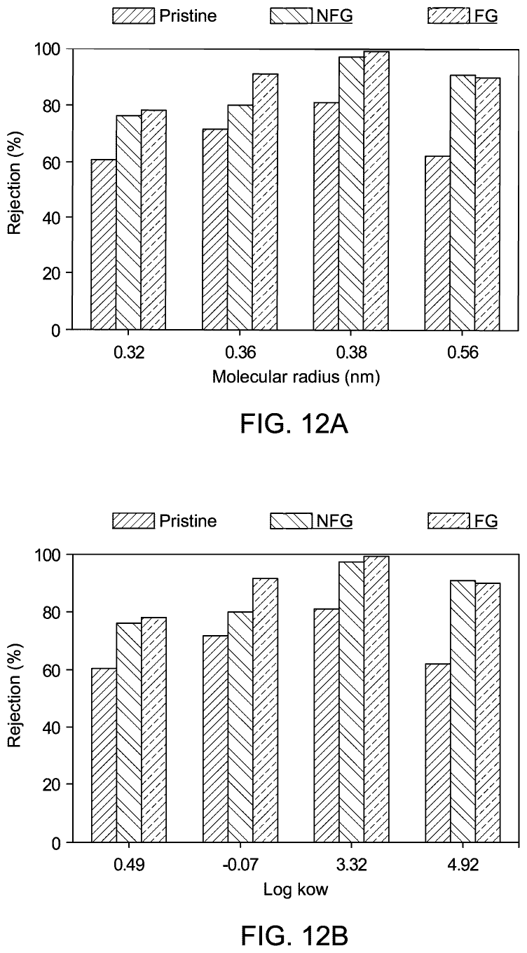

For the moderately hydrophobic Bisphenol A with a molecular weight of ˜228 g/mol, the removal efficiency is ˜80% for the TFC membrane and nearly complete for the membranes incorporating functionalized graphene oxide. This again corresponds to an 18% increase in rejection after the modification with nanofillers (FIG. 11) and may be attributed to a combination of size exclusion and reduced hydrophobic interactions. Such a removal efficiency of BPA is rarely found in the literature. Ahmad and colleagues developed RO membranes with TiO₂ nanotube-constructed nanochannels for enhanced removal of EDCs from wastewater [Matin, A., Baig, N., Anand, D., Ahmad, I., Sajid, M., Nawaz, M. S., 2023a. Thin-film nanocomposite membranes for efficient removal of emerging pharmaceutical organic contaminants from water. Environ Res 237, 116905]. In spite of the hydrophilic nature of the membrane modified with 0.01% TiO₂, the maximum BPA rejection was around 89%. The most significant enhancement in removal is observed for the highly hydrophobic and moderate MW Amitriptyline HCl (FIG. 11). From only ˜60% with the pristine TFC; the rejection efficiency reaches a high of 90% for the modified one. In spite of having the largest molecule of the four molecules in size, the rejection of ATT HCl in comparison to the other organic molecules by the TFC membrane is the lowest (FIG. 12A). This can be explained by its highly hydrophobic nature as indicated by the log Know value (FIG. 12B). The aromatic groups in the compound interact with similar groups in the polyamide active layer and subsequently diffuse to the permeate side. Incorporating amine-functionalized GO increases the proportion of hydrophilic groups in the active layer, both from the N—H groups from the silane and the OH and COOH from the oxide. The abundance of these moieties discourages and suppresses the hydrophobic interactions, resulting in the reduced passage of the ATT molecule.

In practice, wastewater effluents are often a complex mixture of organics, colloids, and microorganisms after primary and secondary treatments. They contain a variety of OMPs with different characteristics, e.g., molecular weight, electric charge, and wetting behavior. Many of them are classified as hazardous to human health and the environment, even in trace concentrations (˜ ng/L). Hence, their removal from the water streams is critical as they contaminate ground and surface waters. For any treatment method to be effective, it should be able to substantially or completely remove these compounds or degrade these compounds to harmless byproducts.

Due to their capability of rejecting small-sized solutes, NF/RO membranes have emerged as promising candidates for this application. However, unlike salt ions, the rejection of trace organic compounds is complicated due to the different interactions and mechanisms involved. One limitation with current NF/RO membranes, which are polyamide thin-film composite (TFC) membranes, is their poor rejection of small-sized, electrically neutral, and very hydrophilic organic molecules.

In view of the above, techniques herein are very promising in that the membranes with functionalized GO nanosheets can efficiently remove OMPs from the above difficult-to-remove categories. These include both hydrophilic (CFN & ACT) and hydrophobic (BPA & ATT HCl) compounds, small-sized molecules (ACT & CFN), and electrically neutral. Additionally, the membrane exhibits a high level of consistency in the removal efficiencies for several hours of continuous running. This attribute is desirable because, in reality, several membranes initially show a high rejection that declines after some time due to sorption and desorption events. Although longer-term (24-48 hours) experiments need to be performed to validate this hypothesis, 6-7 hours is sufficient for sorption-desorption effects to appear.

For economic reasons, having a high-flux membrane that enables clean water production at a faster rate, or the possibility of operation at lower pressures is highly desirable. Moreover, maintaining the level of permeate flux in long-term operation is also critical. The functionalized GO membrane shows a good permeate flux (˜30 LMH at 14 bars), comparable to or even better than several commercial RO membranes. The presence of graphene oxide and the amine functional groups uniformly distributed throughout the active layer will mitigate the fouling problem. This implies that the membrane can maintain a decent flux level after prolonged exposure to various OMPs and other foulant types, such as microorganisms.

To conclude, in the preferred embodiment, thin-film nanocomposite membranes incorporating functionalized graphene oxide nanosheets in the polyamide active layer were synthesized using a triamine monomer. The presence of GO nanosheets and their functionalities in the membrane active layer was confirmed by several characterization techniques. FTIR spectra showed the characteristic peaks associated with graphene oxide and the functional groups N—H and SiO₂. The sheet-like structure was clearly distinguishable in the SEM images at different magnifications. The modification resulted in enhanced hydrophilicity with a CA<10°. Surface roughness was increased from ˜20 nm for the TFC membrane to ˜30 nm for the FG membrane.

Advantages of functionalizing the graphene oxide are shown in the filtration studies, with the FG membrane showing an increase of ˜25% in pure water permeability. This was attributed to the uniform and homogeneous distribution of the GO nanosheets that served as nanochannels for water molecules to pass through easily. In contrast, the mere incorporation of raw GO in the membrane resulted in reduced permeance, which was attributed to agglomeration.

The modified membranes removed the pharmaceutical compounds with very high efficiency compared to the pristine TFC membrane, with the rejection levels of the former being 20-30% higher than the latter. More importantly, the high removal efficiencies for the different OMPs were maintained for several hours.

The present disclosure demonstrates the excellent potential of the TFN membranes incorporating functionalized GO nanosheets for water and wastewater treatment applications. The ability of the novel membrane to remove commonly found organic micropollutants with high efficiency could offer a potential solution to the existing crisis of ground/surface/drinking water contamination. In addition, the higher water permeability compared to conventional polyamide membranes could improve the economics of the overall process. Future studies will focus on removing more OMPs, including pharmaceuticals, personal care products, pesticides, industrial chemicals, etc.

Numerous modifications and variations of the present disclosure are possible in light of the above teachings. It is therefore to be understood that within the scope of the appended claims, the invention may be practiced otherwise than as specifically described herein.

1. A filtration membrane, comprising:
a polysulfone (PFS) membrane support; and
a crosslinked polyamide layer disposed on the PFS membrane support and comprising a network formed by polycondensation between diethylenetriamine and trimesoyl chloride, and graphene oxide (GO) nanosheets covalently bonded to the network via a linking spacer, wherein
the linking spacer includes a backbone chain having at least 8 backbone atoms, the backbone chain having a plurality of amine groups including —NH— and —NH₂, and
the linking spacer is bonded to the graphene oxide nanosheets via a —Si—O— bond, and bonded to the network.

2. The filtration membrane of claim 1, wherein:
the linking spacer conforms to a formula of *—SiR¹R²—[R³—NL]ₓ-R⁴—NH—**
* represents one end of the linking spacer bonded to an oxygen atom of the GO nanosheets,
** represents another end of the linking spacer bonded to a carbonyl group of the network,
R¹ and R² are each independently a hydroxyl group, a methyl group or an ethyl group,
R³ is a hydrocarbon group having 1-12 carbon atoms,
L is a hydrogen atom or a single bond connected to a carbonyl group of the network,
x is an integer of 1 or more, where when x is an integer of 2 or more, each R³ is independently a hydrocarbon group having 1-12 carbon atoms, and each L is independently a hydrogen atom or a single bond connected to a carbonyl group of the network, and
R⁴ is a hydrocarbon group having 1-12 carbon atoms.

3. The filtration membrane of claim 2, wherein:
R¹ and R² are each independently a hydroxyl group or a methyl group,
R³ is a hydrocarbon group having 1-4 carbon atoms,
x is an integer of 1 to 6, where when x is an integer of 2 to 6, each R³ is independently a hydrocarbon group having 1-4 carbon atoms, and each L is independently a hydrogen atom or a single bond connected to a carbonyl group of the network, and
R⁴ is a hydrocarbon group having 1-4 carbon atoms.

4. The filtration membrane of claim 3, wherein:
the linking spacer conforms to a formula of *—Si(OH)₂—(CH₂)₃—N(L₁)-(CH₂)₂—N(L₂)-(CH₂)₂—NH—**,
L₁ is a hydrogen atom or a single bond connected to a carbonyl group of the network, and
L₂ is a hydrogen atom or a single bond connected to a carbonyl group of the network.

5. The filtration membrane of claim 4, wherein:
at least one of L₁ or L₂ is a single bond connected to a carbonyl group of the network.

6. The filtration membrane of claim 1, wherein the filtration membrane is formed by:
refluxing a mixture of GO, a silane agent and a solvent to obtain amine-functionalized GO nanosheets, the silane agent comprising the plurality of amine groups including —NH— and —NH₂;
dipping the PFS membrane support in a first solution comprising the amine-functionalized GO nanosheets and diethylenetriamine;
removing the PFS membrane support from the first solution;
contacting the PFS membrane support with a second solution comprising trimesoyl chloride to form an initial film on the PFS membrane support; and
crosslinking the initial film to obtain the filtration membrane.

7. The filtration membrane of claim 6, wherein:
the silane agent conforms to a formula of Si(R⁵)_{y}(R⁶)_{z}—[R³—NL]ₓ-R⁴—NH₂,
R⁵ each is independently a hydrolyzable group selected from the group consisting of a halogen atom and an alkoxyl group having 1-3 carbon atoms,
R⁶ each is independently a methyl group or an ethyl group,
y+z=3, where y is an integer of 1, 2 or 3, and z is an integer of 0, 1 or 2,
R³ is a hydrocarbon group having 1-12 carbon atoms,
L is a hydrogen atom or a single bond connected to a carbonyl group of the network,
x is an integer of 1 or more, where when x is an integer of 2 or more, each R³ is independently a hydrocarbon group having 1-12 carbon atoms, and each L is independently a hydrogen atom or a single bond connected to a carbonyl group of the network, and
R⁴ is a hydrocarbon group having 1-12 carbon atoms.

8. The filtration membrane of claim 7, wherein:
the silane agent includes at least one selected from the group consisting of 2-[2-(3-trimethoxysilylpropylamino)ethylamino]ethylamine, N-(2-Aminoethyl)-11-aminoundecyltrimethoxysilane, N-(6-aminohexyl)aminomethyltriethoxy silane, N-2-(aminoethyl)-3-aminopropylmethyldimethoxysilane and N-2-(aminoethyl)-3-aminopropyltrimethoxysilane.

9. The filtration membrane of claim 8, wherein:
the silane agent includes 2-[2-(3-trimethoxysilylpropylamino)ethylamino]ethylamine.

10. The filtration membrane of claim 6, wherein the filtration membrane is further formed by:
preparing a dispersion of GO in ethanol by ultrasonication; and
adding the silane agent to the dispersion of GO to form the mixture, wherein
the refluxing is executed at a temperature of 80° C. for 12 hours to obtain the amine-functionalized GO nanosheets;
the PFS membrane support was dipped in the first solution for about 5 minutes; and
the crosslinking is executed at about 60° C. for about 10 minutes.

11. The filtration membrane of claim 1, wherein:
the crosslinked polyamide layer is in the form of the GO nanosheets interspersed among particles.

12. The filtration membrane of claim 11, wherein:
the particles have a lateral dimension of 50-300 nm, and
the GO nanosheets have a lateral dimension of 100-900 nm.

13. The filtration membrane of claim 1, wherein:
the GO nanosheets are not stacked or stacked by no more than 3 layers.

14. The filtration membrane of claim 1, wherein:
the network is formed by polycondensation between diethylenetriamine, trimesoyl chloride, and diethylenetriamine-siloxy functionalized GO nanosheets, and
the diethylenetriamine-siloxy functionalized GO nanosheets are reacted with the trimesoyl chloride and the diethylenetriamine.

15. A filtration method, comprising:
filtering a mixture comprising water and an organic molecule through the filtration membrane of claim 1 to generate a water permeate.

16. The filtration method of claim 15, wherein:
the organic molecule includes at least one selected from the group consisting of acetaminophen, caffeine and bisphenol A.

17. The filtration method of claim 15, wherein:
the organic molecule includes caffeine,
a rejection efficiency of the filtration membrane is about 20% higher than a first comparative membrane that is the same as the filtration membrane but does not include the GO nanosheets and the linking spacer, and
a rejection efficiency of a second comparative membrane is about 8% higher than the first comparative membrane, the second comparative membrane being the same as the filtration membrane but not including the GO nanosheets.

18. The filtration method of claim 15, wherein:
the organic molecule includes bisphenol A,
a rejection efficiency of the filtration membrane is about 30% higher than a comparative membrane that is the same as the filtration membrane but does not include the GO nanosheets and the linking spacer.

19. The filtration method of claim 15, wherein:
a water flux rate of the filtration membrane is about 25% higher than a comparative membrane that is the same as the filtration membrane but does not include the GO nanosheets and the linking spacer.

20. The filtration method of claim 15, further comprising:
adjusting a flux rate and permeability of the filtration membrane by changing a length of the linking spacer.
